(19) United States
(12) Patent Application Publication
(10) Pub. No.: US 2025/0134774 A1
(43) Pub. Date: May 1, 2025

(54) MEDICATION SUPPORT APPARATUS

(71) Applicants: Manabu Yamanaka, Kanagawa (JP); Terumitsu Azuma, Kanagawa (JP); Yoshihide Sugiyama, Kanagawa (JP); Hiroshi Fujie, Kanagawa (JP); Hirotaka Hayashi, Kanagawa (JP); Takato Mochizuki, Kanagawa (JP); Youhei Niitsuma, Kanagawa (JP); Yu Yamaya, Kanagawa (JP); Sachika Tashiro, Kanagawa (JP)

(72) Inventors: Manabu Yamanaka, Kanagawa (JP); Terumitsu Azuma, Kanagawa (JP); Yoshihide Sugiyama, Kanagawa (JP); Hiroshi Fujie, Kanagawa (JP); Hirotaka Hayashi, Kanagawa (JP); Takato Mochizuki, Kanagawa (JP); Youhei Niitsuma, Kanagawa (JP); Yu Yamaya, Kanagawa (JP); Sachika Tashiro, Kanagawa (JP)

(73) Assignee: Ricoh Company, Ltd., Tokyo (JP)

(21) Appl. No.: 18/912,787

(22) Filed: Oct. 11, 2024

(30) Foreign Application Priority Data
Oct. 26, 2023 (JP) 2023-184160
May 13, 2024 (JP) 2024-078022

(51) Int. Cl. A61J 7/00; B25J 15/06; B65G 1/04; B65G 47/91

(52) U.S. Cl. CPC A61J 7/0084; A61J 7/0069; B65G 1/0471; B65G 47/914; A61J 2205/10; B65G 2201/0238; B65G 2201/0258

(57) ABSTRACT

A medication support apparatus includes a container to store medicine packs, a pickup device including a suction device to pick up specific one of the medicine packs from the container, and a suction-device guide to change a posture of the suction device, a conveyor to move the pickup device, and processing circuitry configured to control an operation to pick up the medicine pack by the pickup device. When the suction device fails to pick up the medicine pack at a first pickup position indicating a certain amount of rise of the suction device relative to the medicine packs in the container, the processing circuitry controls the suction device to pick up the medicine pack at a second pickup position indicating another amount of rise of the suction device greater than the certain amount of rise of the suction device at the first pickup position.

### CROSS-REFERENCE TO RELATED APPLICATIONS

This patent application is based on and claims priority pursuant to 35 U.S.C. § 119(a) to Japanese Patent Application Nos. 2023-184160 and 2024-078022, filed on Oct. 26, 2023, and May 13, 2024, respectively, in the Japan Patent Office, the entire disclosures of which are hereby incorporated by reference herein.

### BACKGROUND

### Technical Field

The present disclosure relates to a medication support apparatus.

### Background Art

Medication support devices in which the posture or attitude of a suction device is variable have been proposed. Such technologies are developed to take out a medicine pack whose suction and pickup once failed. After the suctioning of the medicine pack ends in failure, the position of the suction device is changed, and an attempt to suck up the medicine pack is made again. In other medication support devices, suctioning operation is performed upon changing the height of a suction device or the position in the direction toward an object to be sucked up depending on the type or kind of such an object to be sucked up, such that medicines of various sizes stored in a container can be taken out. Some other medication support devices are provided with a pushing-up rod under a container for the purposes of changing the posture or attitude of the medicines stored in a container.

### SUMMARY

The present disclosure described herein provides a medication support apparatus including a container to store a plurality of medicine packs, a pickup device including a suction device to pick up specific one of the plurality of medicine packs from the container, and a suction-device guide to change a posture of the suction device, a conveyor to move the pickup device, and processing circuitry configured to control an operation to pick up the specific one of the plurality of medicine packs by the pickup device. When the suction device fails to pick up the specific one of the plurality of medicine packs at a first pickup position indicating a certain amount of rise of the suction device relative to the plurality of medicine packs in the container, the processing circuitry controls the suction device to pick up the specific one of the plurality of medicine packs at a second pickup position indicating another amount of rise of the suction device greater than the certain amount of rise of the suction device at the first pickup position.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1A is a front view of a medication support device in its entirety.

FIG. 1B is a side view of the medication support device of FIG. 1A.

FIG. 2A is a typical plan view of a single medicine package.

FIG. 2B is a side view of the single medicine package of FIG. 2A viewed in a direction indicated by an arrow A.

FIG. 2C is a side view of bound medicine packages viewed in a direction indicated by an arrow B.

FIG. 2D is a diagram illustrating a typical form of continuous packs.

FIG. 3 is an external perspective view of a medicine dispensing tray provided with subdivision boxes.

FIG. 4 is an external perspective view of a medicine dispensing tray without subdivision boxes.

FIG. 5A is a vertical sectional view of a cartridge.

FIG. 5B is a bottom view of the cartridge of FIG. 5A.

FIG. 6 is a schematic plan sectional view of the attaching and detaching mechanisms for a cartridge.

FIG. 7 is a plan view of a cartridge, illustrating the mechanisms for recognizing and identifying the cartridge.

FIG. 8A is a front view of a carriage, illustrating a schematic configuration or structure of the carriage.

FIG. 8B is a plan view of the carriage of FIG. 8A.

FIG. 9 is a magnified view of a guide groove on a guide unit provided for a carriage.

FIG. 10A to FIG. 10D are diagrams illustrating the progression of the posture-changing operations of a suction device.

FIG. 11A and FIG. 11B are front views of a carriage, illustrating the progression of the picking-out operation of the carriage.

FIG. 12A, FIG. 12B, and FIG. 12C are front views of a carriage, illustrating the progression of the picking-out operation of the carriage subsequent to FIG. 11A and FIG. 11B.

FIG. 13 is a flowchart of the picking-out operation of a carriage.

FIG. 14A, FIG. 14B, and FIG. 14C are front views of a carriage, illustrating the progression of the placing operation of the carriage.

FIG. 15A and FIG. 15B are diagrams illustrating a case in which the front edges of medicine packages are caught by a side face of a cartridge.

FIG. 16A is a front view of a conveyor, illustrating a schematic configuration of the conveyor.

FIG. 16B is a side view of the conveyor of FIG. 16A.

FIG. 17 is a control block diagram illustrating a schematic control structure for the medication support device of FIG. 1A and FIG. 1B.

FIG. 18 is a diagram illustrating the control blocks of a medication support device, viewed from a different angle compared with FIG. 17.

FIG. 19A, FIG. 19B, and FIG. 19C are front views of a carriage according to the first example, illustrating the progression of the picking-out operation of the carriage.

FIG. 20A and FIG. 20B are front views of a carriage according to the first example, illustrating the progression of the picking-out operation of the carriage subsequent to FIG. 19A, FIG. 19B, and FIG. 19C.

FIG. 21 is a flowchart of the picking-out operation of a carriage according to the first example.

FIG. 22 is a flowchart of the picking-out operation of a carriage according to a modification of the first example.

FIG. 23A, FIG. 23B, and FIG. 23C are front views of a carriage according to the second example, illustrating the progression of the picking-out operation of the carriage.

FIG. 24A, FIG. 24B, and FIG. 24C are front views of a carriage according to the second example, illustrating the progression of the picking-out operation of the carriage subsequent to FIG. 23A, FIG. 23B, and FIG. 23C.

FIG. 25 is a flowchart of the picking-out operation of a carriage according to the second example.

FIG. 26A, FIG. 26B, and FIG. 26C are front views of a carriage, illustrating the progression of a retrying operation to be performed after suctioning has failed, which is a part of the picking-out operation of the carriage according to the third example.

FIG. 27 is a flowchart of the picking-out operation of a carriage according to the third example.

FIG. 28A, FIG. 28B, and FIG. 28C are front views of a carriage, illustrating the progression of a retrying operation to be performed after suctioning has failed, which is a part of the picking-out operation of the carriage according to the fourth example.

FIG. 29A and FIG. 29B are front views of a carriage according to the fourth example, illustrating the progression of the picking-out operation of the carriage subsequent to FIG. 28A, FIG. 28B, and FIG. 28C.

FIG. 30A and FIG. 30B are a flowchart of the picking-out operation of a carriage according to the fourth example.

FIG. 31A and FIG. 31B are front views of a carriage according to the fifth example, illustrating the operation and structure of the carriage.

FIG. 32A, FIG. 32B, and FIG. 32C are front views of a carriage, illustrating the progression of a retrying operation to be performed after suctioning has failed, which is a part of the picking-out operation of the carriage according to the fifth example.

FIG. 33 is a flowchart of the picking-out operation of a carriage according to the fifth example.

FIG. 34A, FIG. 34B, and FIG. 34C are front views of a carriage, illustrating the progression of a retrying operation to be performed after suctioning has failed, which is a part of the picking-out operation of the carriage according to the sixth example.

FIG. 35A, FIG. 35B, and FIG. 35C are front views of a carriage according to the sixth example, illustrating the progression of the picking-out operation of the carriage subsequent to FIG. 34A, FIG. 34B, and FIG. 34C.

FIG. 36A and FIG. 36B are flowcharts of the picking-out operation of a carriage according to the sixth example.

FIG. 37 is a front view of a carriage according to the seventh example, illustrating a schematic configuration or structure of the carriage.

FIG. 38 is diagram illustrating the control blocks of a medication support device according to the seventh example.

FIG. 39A and FIG. 39B are front views of a carriage, illustrating the progression of a retrying operation to be performed after suctioning has failed, which is a part of the picking-out operation of the carriage according to the seventh example.

FIG. 40A and FIG. 40B are front views of a carriage according to the seventh example, illustrating the progression of the picking-out operation of the carriage subsequent to FIG. 39A and FIG. 39B.

FIG. 41 is a flowchart of the picking-out operation of a carriage according to the seventh example.

FIG. 42 is a flowchart of the picking-out operation of a carriage according to the eighth example.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Embodiments of the present disclosure and examples of the present disclosure are described below in detail with reference to the accompanying drawings. In the drawings and the description of the embodiments and examples of the present disclosure, like reference signs denote like elements such as members or components of similar shapes or similar functionality unless there is concern about the possibility of confusion.

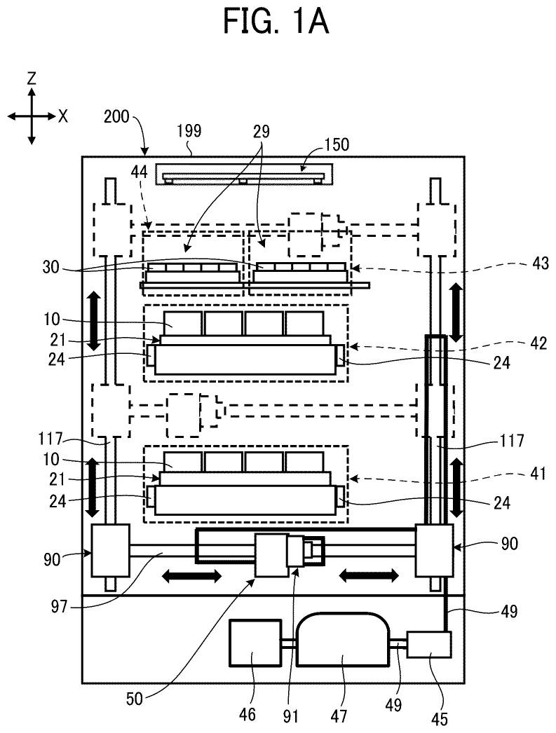

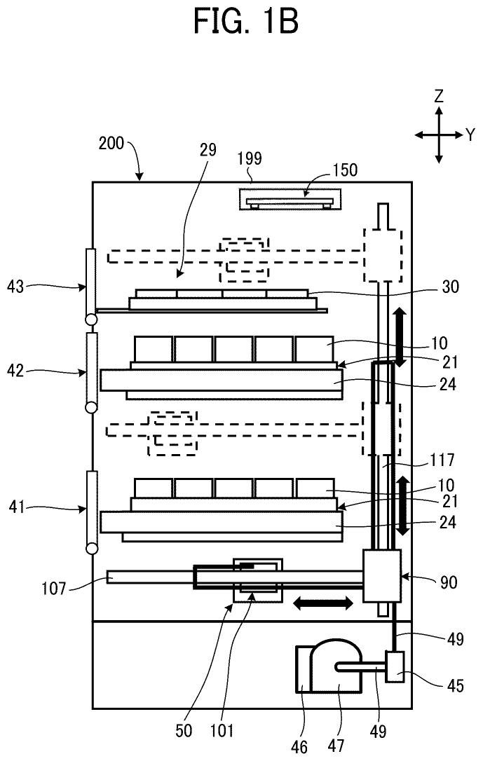

A basic and overall configuration or structure of a medication support device 200 is described with reference to FIG. 1A and FIG. 1B.

FIG. 1A is a schematic front view of the medication support device 200 in its entirety.

FIG. 1B is a schematic side view of the medication support device 200 of FIG. 1A.

As illustrated in FIG. 1A and FIG. 1B, the medication support device 200 is provided with a cartridge 10 that is also referred to as a container, a medicine dispensing tray 30, a carriage 50 that is also referred to as a pickup device, a conveyor 90, and a first gate 41 to a fourth gate 44. In FIG. 1A and FIG. 1B, the lateral direction, the depth direction, and the vertical direction of the medication support device 200 are referred to as the X-axis direction, the Y-axis direction, and the Z-axis direction, respectively.

Each one of the multiple cartridges 10 serves as a container in which medicine packages 2 packing several kinds of medicines 3, as will be described later in detail, are stored upon being stacked on top of each other in layers. The medicine package 2 may be referred to simply as a pack or a medicine pack in the following description. The multiple cartridges 10 are arranged at an upper portion and lower portion of a housing 199 of the medication support device 200. The expression “stored upon being stacked on top of each other in layers” in the present disclosure indicates keeping the packs horizontally in such a manner that the front face is viewable.

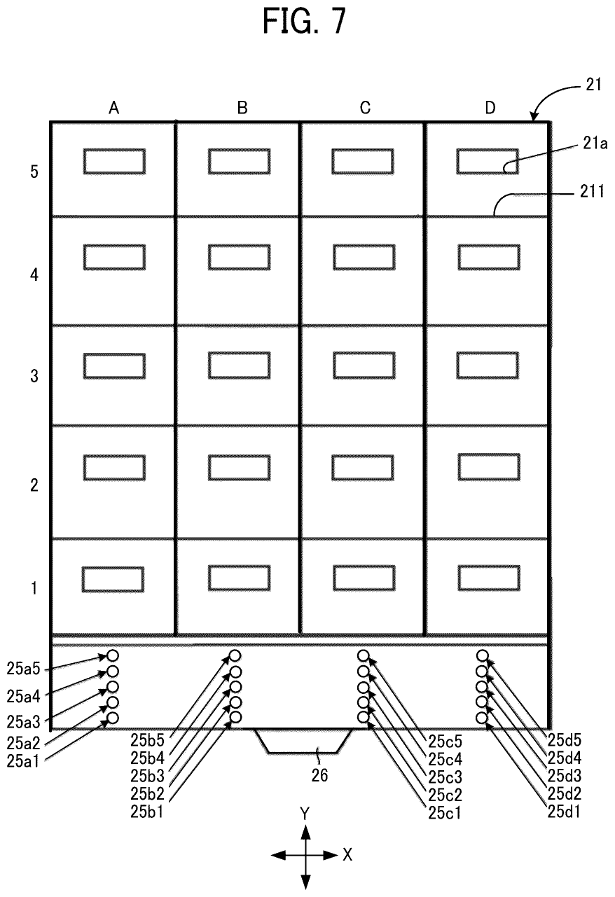

The multiple cartridges 10 are placed in a pair of drawers 21 arranged at the lowermost portion and middle portion of a housing 199 of the medication support device 200. In the case of the medication support device 200 as illustrated in FIG. 1A and FIG. 1B, twenty cartridges 10 (4×5=20) are placed and held in one of the drawers 21 (see FIG. 7). Each of the pair of drawers 21 serves as a second container in which at least one of the multiple cartridges 10 is placed and held. Each of the multiple cartridges 10 is placed and housed in a partitioned lattice-like side wall and bottom wall in the drawer 21. On the bottom wall of the drawer 21 of corresponding ones of the multiple cartridges 10, a rectangular through opening 21a through which a pack can be picked up from below one of the multiple cartridges 10, making use of the elasticity or free deformation of the pack as will be described later in detail in relation to the operation, is formed (see FIG. 7).

Each one of the multiple medicine dispensing trays 30 is an example of a medicine dispenser or medicine dispensing table in which the prescribed packs conveyed by the conveyor 90 are arranged. In the present embodiment described with reference to FIG. 1A and FIG. 1B, two medicine dispensing trays 30 each of which has twenty (=4×5) rooms 33 are arranged above the multiple cartridges 10 arranged at an upper portion of the housing 199. The areas that include the medicine dispensing trays 30 where the packs are passed to the medicine dispensing tray 30 for automatic medicine dispensing are referred to as medicine dispensing areas 29 in the following description.

The carriage 50 is an example of a pickup device that picks up specific one of the medicine packs from the cartridge 10. The conveyor 90 is an example of a conveyor that conveys the pack picked up from one of the cartridges 10 using the carriage 50.

Each of the first gate 41 and the second gate 42 is an example of an entrance and exit gate for the container, which allows one of the multiple cartridges 10 to enter and exit the housing 199. The multiple cartridges 10 are inserted and set in the housing 199 through each one of the first gate 41 and the second gate 42. The open and close door of one of the first gate 41 and the second gate 42 are opened, and the drawer 21 in which the multiple cartridges 10 are aligned is drawn out to the front side. By so doing, the cartridges 10 are inserted or withdrawn.

The third gate 43 and the fourth gate 44 are examples of a pair of entrance and exit gates for the medicine dispenser, which allow the multiple medicine dispensing trays 30 that are arranged in two rows at the uppermost stage of the medication support device 200 to enter and exit the housing 199. The third gate 43 and the fourth gate 44 are arranged such that the packs can be taken out immediately after the packs are set or inserted into the medicine dispensing tray 30.

As illustrated in FIG. 1A, the medication support device 200, two medicine dispensing trays 30 are arranged as described above, and as will be described later in detail, the medicine dispensing trays 30 are arranged for each time of medication such as a time in the morning, a time in the daytime, a time in the evening, and a time before going to bed. The third gate 43 and the fourth gate 44 for the medicine dispensing tray 30 are also arranged for each one of the medicine dispensing trays 30. Due to such a configuration, another different one of the medicine dispensing trays 30 can be taken out even when the medicine dispersing operation is performed on a particular one of the multiple medicine dispensing trays 30.

The drawers 21 of the multiple cartridges 10 as illustrated in FIG. 1A and FIG. 1B are collectively arranged in two stages on the upper and lower sides under the medicine dispensing trays 30 at the uppermost stage. However, no limitation is intended thereby, and the drawers 21 may collectively be arranged on the upper side or the lower side. Depending on the number of persons in the day-care center or nursing home, the multiple cartridges 10 may be arranged in three stages.

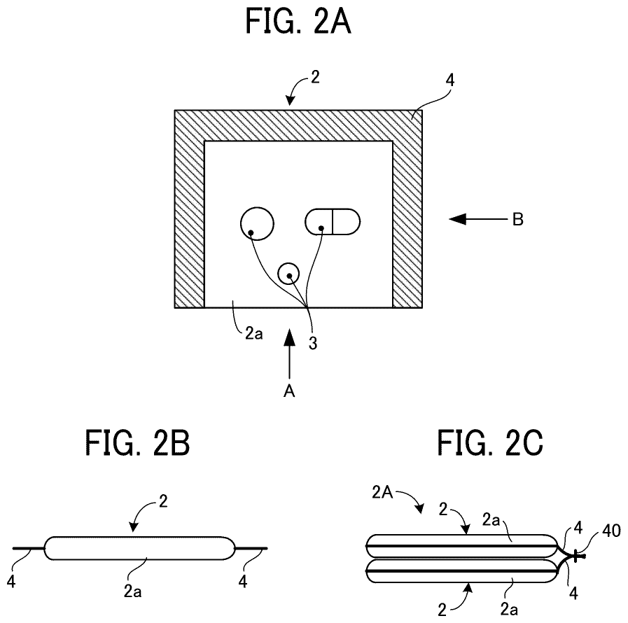

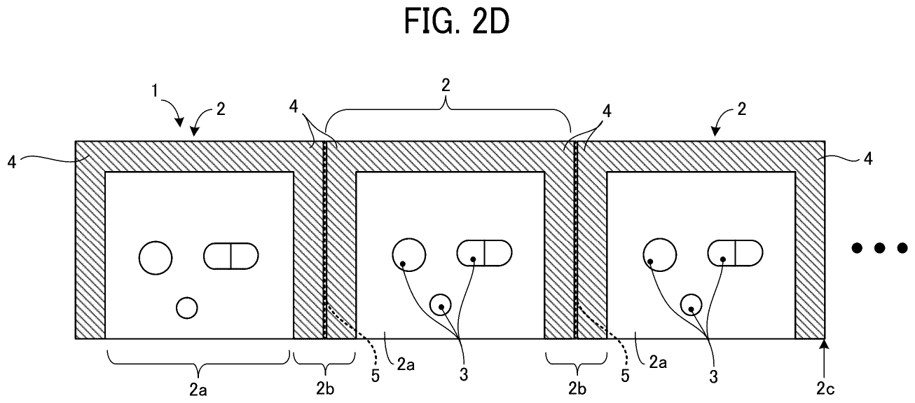

FIG. 2A is a typical plan view of a single medicine package 2.

FIG. 2B a side view of the single medicine package 2 of FIG. 2A viewed in a direction indicated by an arrow A.

FIG. 2C is a side view of bound medicine packages 2A viewed in a direction indicated by an arrow B, where such bound medicine packages 2A are obtained by combining the multiple medicine packages 2.

FIG. 2D is a diagram illustrating a typical form of continuous packs 1.

The medicine pack includes the single medicine package 2 and bound medicine packages 2A in which multiple medicine packages 2 are stacked on top of each other in layers and bound by a staple 40 or the like. In FIG. 2C, two medicine packages 2 are bound as the bound medicine packages 2A. Except for FIG. 2A to FIG. 2D, a single medicine package 2 is illustrated. However, as a matter of course, the bound medicine packages 2A is also included even when only a single medicine package 2 is illustrated. As illustrated in FIG. 2A, one medicine package 2 is formed of, for example, a resin film, and medicines 3 such as capsules or tablets are packed in small quantities. The medicine package 2 includes a bag 2a that covers the medicines 3 and a pressure-bonded portion 4 in which three sides of the bag 2a are pressure-bonded or welded. The pressure-bonded portion 4 is hatched in FIG. 2A and FIG. 2D. Typically, the side of the medicine package 2 on the bag 2a side is folded into two, and the medicines 3 are packed therebetween. The pressure-bonded portion 4 forms a leakage-preventing portion that prevents the medicines 3 from slipping out from the bag 2a. Typically, the medicines 3 in one medicine package 2 is a one-time dosage for a patient who takes medicines.

The medicine package 2 is dispensed and prepared by a drug-dispensing machine installed in, for example, a pharmacy. The dispensing sheets that are used for dispensing the medicines are rolled long-length sheets, and are perforated between packs. The dispensing sheets are rolled in an overlapping manner, and the medicines 3 to be taken are packed in the space between the sheets. The medicines 3 for a required number of doses are divided into small quantities, and packed into the multiple medicine packages 2 that form a continuous sheet. The three sides other than the folded portion of each one of the multiple medicine packages 2 around the medicines 3 for a single dose are sealed in turn by the pressure-bonded portion 4. The multiple medicine packages 2 that form such a continuous sheet may be referred to as continuous packs 1 in the following description. In the continuous packs 1 that are described with reference to FIG. 2D, the multiple medicine packages 2 are coupled to each other and laid like a belt. In the present embodiment described with reference to FIG. 2D, the medicines 3 for three doses are illustrated.

The continuous packs 1 are a typical form of drug or medicine that is given or sold at a pharmacy or the like to, for example, a user such as a person who actually takes the medicine 3 in the medicine package 2 and a personal care attendant or assistant who helps or assists the user to take medication, or a staff or the like including a pharmacist, a nurse practitioner, a care manager, or a medication assistant of, for example, various kinds of day-care center, nursing home, or medical institution.

For the sake of explanatory convenience, each one of the packs is filled with the medicines 3 of the same form in the following description. In FIG. 2C, by way of example, each one of the packs is filled with the same capsule and the same tablets. However, no limitation is indicated thereby. As a matter of course, each one of the packs may be filled with different types of medicines depending on, for example, the usage or purposes of the medication.

In the present embodiment described with reference to FIG. 2A to FIG. 2D, the medicine package 2 has a rectangular shape in a plan view, and a packaging method in which three sides are crimped and sealed as in the present embodiment is called three-sided packaging in the related art. Most of the drug-dispensing machines available on the market make packs using the three-sided packaging method.

The pressure-bonded portion 4 has a band-like width of about 10 to 15 millimeters (mm), and has higher rigidity than the portion of the bag 2a that is a transparent or semitransparent film where the medicines 3 can be visually recognized therethrough. A boundary portion 2b that is implemented by perforation 5 is formed in the center of the pressure-bonded portion 4 between a pair of the multiple medicine packages 2 making up the continuous packs 1. The multiple medicine packages 2 are adjacent to each other in an upstream-to-downstream direction. For example, a user who is not handicapped in the hand can obtain one medicine package 2 by tearing off at the perforation 5 by hand or by cutting near the perforation 5 with scissors or a dedicated cutter.

As illustrated in FIG. 2C, the bound medicine packages 2A may be used. The bound medicine packages 2A is formed by fastening medicine packages 2 at the center of the three sides of the pressure-bonded portions 4 by stapling 40 or the like. In FIG. 2C, two medicine packages 2 are fastened together.

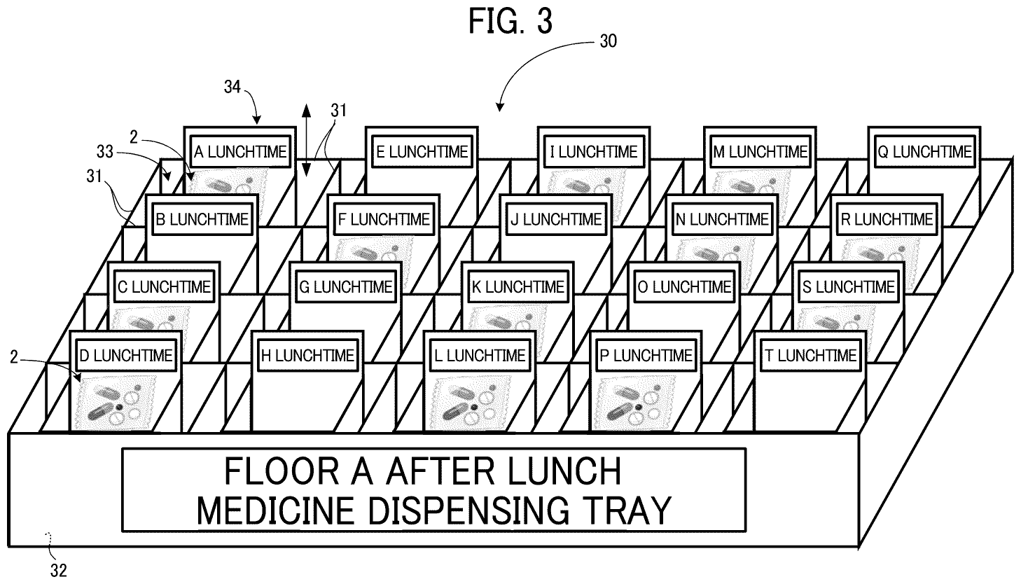

FIG. 3 is an external perspective view of the medicine dispensing tray 30 provided with subdivision boxes 34.

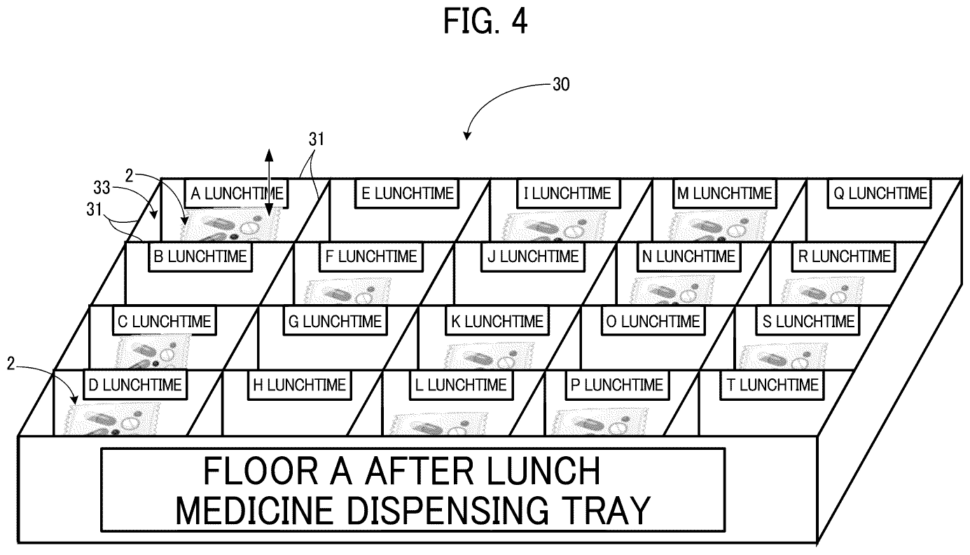

FIG. 4 is an external perspective view of the medicine dispensing tray 30, where prescribed one of the medicine packages 2 is dispensed to desired one of the rooms 33 without involving the subdivision boxes 34.

As illustrated in FIG. 3 and FIG. 4, each one of the multiple medicine dispensing trays 30 has partition walls 31 that serve as a plurality of dividers for arranging prescribed packs, and is partitioned by four upright partition walls 31. The twenty rooms 33 that are formed in each one of the multiple medicine dispensing trays 30 can be expressed as the components of a matrix including five columns in the X-axis direction or the line feed direction and four rows in the Y-axis direction or the character feed direction. As a result, each one of the twenty rooms 33 of the medicine dispensing trays 30 can be uniquely positioned based on the components and addresses of the matrix of five columns and four rows. Furthermore, each one of the multiple medicine dispensing trays 30 has a bottom wall 32 on which the multiple medicine packages 2 are placed. As described above, each one of the medicine dispensing trays 30 is arranged such that prescribed one of the medicine packages 2 arranged in specific one of the rooms 33 will be placed in specific one of the rooms 33 with reliability by the multiple partition walls 31, which are four partition walls in the present embodiment, and the bottom wall 32 in common, without being mixed up with packs in different one of the rooms 33 or dropping off from the bottom wall 32.

FIG. 3 illustrates one of the medicine dispensing trays 30 where a subdivision box 34 attachable to and detachable from each one of the multiple rooms 33 is used, illustrating a state where the medicine dispensing operation is complete after the medicine package 2 is picked up from one of the cartridges 10 and is dispensed to one of the subdivision boxes 34 several times.

For example, the multiple subdivision boxes 34 hold the multiple medicine packages 2 filled with the medicines 3 to be taken by twenty residents A to T after lunch in a day-care center or nursing home. In other words, one of the multiple medicine dispensing trays 30 illustrated in FIG. 3 is used to arrange prescribed packs in a predetermined or specific one of the multiple rooms 33 partitioned by dividers through the multiple subdivision boxes 34.

As in the medicine dispensing tray 30 illustrated in FIG. 4, the medicine package 2 may directly be dispensed to one of the rooms 33 of the medicine dispensing tray 30 as long as partitioning is done for each times of medication and occupant. The operation of placing the multiple medicine packages 2 in one of the multiple medicine dispensing trays 30 may be described later with a case in which the multiple subdivision boxes 34 are used.

In each one of the multiple rooms 33 of the multiple medicine dispensing trays 30, a setting position or inserting position is determined for each patient who takes medicines depending on the type of medicines in the pack to be taken. In other words, the multiple rooms 33 in one of the multiple medicine dispensing trays 30 may be allocated to patients who take medicines at the same time. In a case where a specific patient who is to take medicines does not take a medicine at a specific time of medication, arrangement can be made such that a pack is not given to such a specific patient at the specific time of medication.

However, no limitation is intended by the medicine dispensing trays 30 described above. Each one of the multiple rooms 33 of one of the medicine dispensing trays 30 may be allocated for each time of medication of each patient who takes medicines. More specifically, in such an alternative embodiment of the present disclosure, the multiple rooms 33 may be allocated to each of the patients who take medicines in view of the time of medication of each one of the multiple medicine packages 2 to be taken in the morning, in the daytime, in the evening, or before going to bed. The medicine dispensing trays 30 of such cases may be managed on a room-by-room basis or a floor-by-floor basis in day-care centers or nursing homes where patients who take medicines reside, and the multiple medicine packages 2 for that day or a couple of days may be dispersed in advance to the multiple medicine dispensing trays 30.

According to the above alternative embodiment, allocating the rooms 33 based on each time of medication such as a time in the morning, a time in the daytime, a time in the evening, and a time before going to bed can prevent the time of medication from being mistaken by patients who take medicines. The configuration or structure of the multiple medicine dispensing trays 30 is not limited to the embodiments of the present disclosure described above, and various kinds of combinations are theoretically possible between patients who take medicines and the timing at which the medicines are to be taken. However, such combinations may go beyond the scope of the present disclosure, the description of such combinations is omitted.

Each one of the medicine dispensing trays 30 is identified in a similar manner to the cartridges 10 whose recognition and identification will be described later in detail. The medicine dispensing trays 30 are recognized and identified using, for example, bar codes, QR CODE, and character recognition.

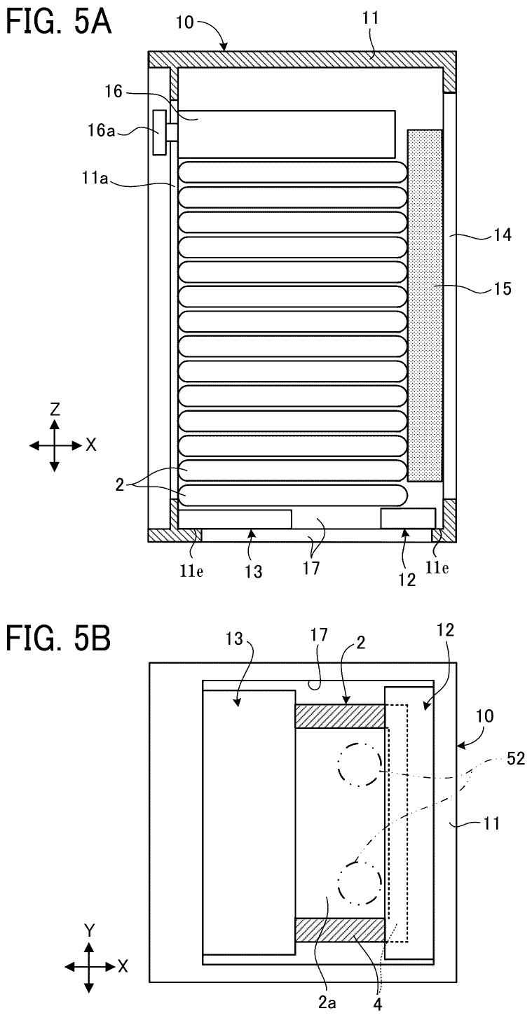

FIG. 5A is a vertical sectional view of the cartridge 10.

FIG. 5B is a bottom view of the cartridge 10 of FIG. 5A.

For example, each one of the multiple cartridges 10 includes a casing 11, a lid 14, a pack pickup slot 17, a movable board 16, a pack posture keeper 15, and a right support portion 12 and a left support portion 13 each of which serves as a support portion.

The casing 11 stores, for example, multiple medicine packages 2 or the bound packages 2A. In the following description, a single medicine package 2 will represent such multiple medicine packages 2 or bound packages 2A. For example, the casing 11 is integrally or separately formed using resin.

The lid 14 enables the multiple medicine packages 2 to be loaded or unloaded.

The pack pickup slot 17 is formed in a lower portion or a bottom portion of the casing 11, and is used to pick up the medicine package 2 in one of the multiple cartridges 10. Moreover, the pack pickup slot 17 allows the medicine package 2, which is picked up from one of the multiple cartridges 10 by the carriage 50 (see, for example, FIG. 1A and FIG. 1B), to pass therethrough.

The movable board 16 prevents the medicine package 2 from falling out, and moves the lowermost one of the medicine packages 2 to a position close to the pack pickup slot 17 after the first one of the maximum number of medicine packages 2 that can be stored in the casing 11 is picked up.

The pack posture keeper 15 keeps the posture of the medicine package 2.

The right support portion 12 and the left support portion 13 also support or hold the medicine package 2 in the casing 11.

In the present embodiment, the to-be-picked-up portion of one of the multiple medicine packages 2 to be picked up from one of the multiple cartridges 10 by the carriage 50 is at a lower portion or bottom portion of the corresponding one of the multiple cartridges 10. In other words, the to-be-picked-up portion includes the pack pickup slot 17, and the right support portion 12 and the left support portion 13 that serve as a pair of support portions or supporting member and support, at multiple points, one of the multiple medicine packages 2 to be picked up from one of the multiple cartridges 10.

When one of the multiple medicine packages 2 is picked up from one of the multiple cartridges 10 by the carriage 50, the right support portion 12 and the left support portion 13 allow one of the multiple medicine packages 2 to pass through. On the other hand, when any one of the multiple medicine packages 2 is not to be picked up from one of the multiple cartridges 10, the right support portion 12 and the left support portion 13 restrict the passage of one of the multiple medicine packages 2 to store and hold the multiple medicine packages 2 in the casing 11.

As described above, the right support portion 12 and the left support portion 13 support or hold the medicine packages 2 in the cartridge 10, and each one of the right support portion 12 and the left support portion 13 is fixed and immovable such that one of the multiple medicine packages 2 can be picked up in a stable manner from one of the multiple cartridges 10 by the carriage 50.

The right support portion 12 and the left support portion 13 are a pair of fixation members that are fixed or attached to the pair of interior walls 1le of the right bottom-wall edge and left bottom-wall edge of the pack pickup slot 17, respectively.

As illustrated in FIG. 5B, the pack pickup slot 17 has a function to allow the pair of suction pads 52 of the carriage 50, each of which serves as an air suction unit or suction unit, to pass therethrough in order to pick up one of the multiple medicine packages 2, and has a function to let the medicine package 2 that is picked up and the pair of suction pads 52 to pass through.

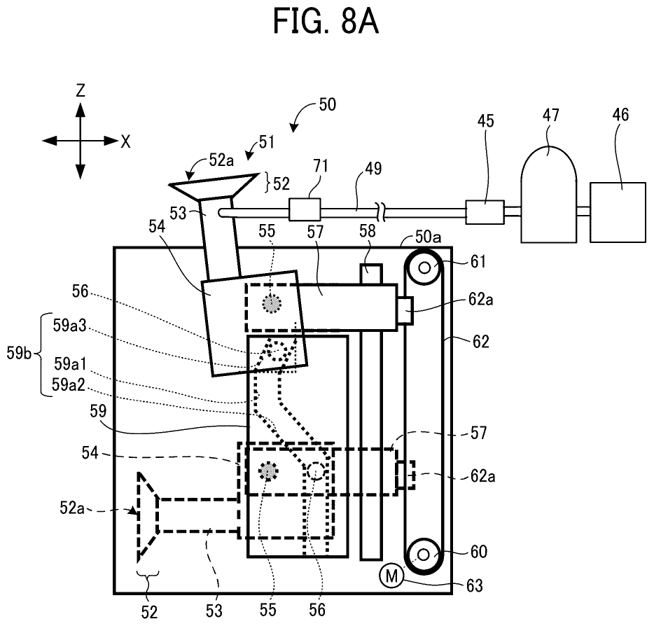

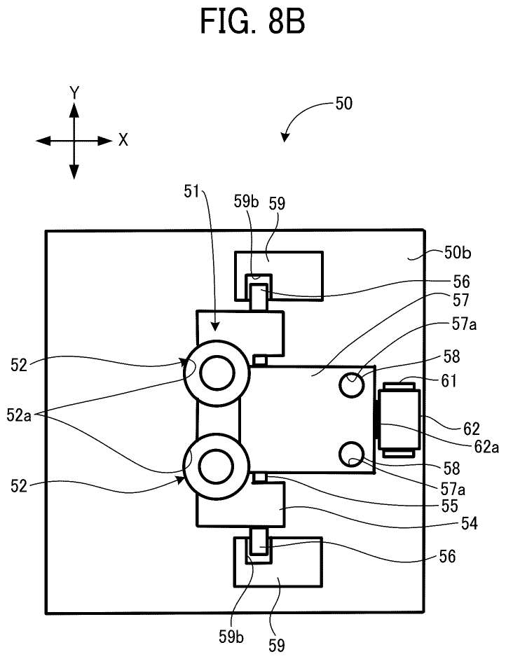

In one of the multiple cartridges 10 illustrated in FIG. 8A and FIG. 8B, a pair of positions at which the pair of suction pads 52 adsorb or suck up one of the multiple medicine packages 2 stored in one of the multiple cartridges 10, as will be described later in detail, are indicated by a pair of ring-shaped dot-dot-dash lines as illustrated in FIG. 5B. Such a pair of positions may be referred to as a pair of suction-pad positions in the following description.

The right support portion 12 and the left support portion 13 support the multiple medicine packages 2 in one of the multiple cartridges 10 such that the multiple medicine packages 2 in one of the multiple cartridges 10 do not fall off from the pack pickup slot 17. As will be described later in detail in regard to the operation of the carriage 50, when the medicine package 2 at the bottom of the cartridge 10 is sucked and picked up by the pair of suction pads 52, one of the multiple medicine packages 2 is sucked by the pair of suction pads 52 at a pair of suction-pad positions in the Y-axis direction near both ends of the right support portion 12. When the lowermost one of the medicine packages 2 is picked up from one of the multiple cartridges 10 by the pair of suction pads 52, the pair of suction pads 52 pass near both ends of the right support portion 12 in the Y-axis direction to suck and hold one of the medicine packages 2.

As illustrated in FIG. 5B, two points at which the pair of suction pads 52 contact the medicine package are arranged near both ends of the right support portion 12 in the Y-axis direction. Due to such a configuration, the possibility of an error in which the suction by the pair of suction pads 52 is disabled can be avoided and prevented, and the picking up operation can successfully be done. In other words, the medicine package 2 is sucked and adhered to the pair of suction pads 52 at both ends in the Y-axis direction, and the bag 2a of the medicine package 2, which is made of film, is stretched and can withstand the deformation. Accordingly, both reliable support or holding of the multiple medicine packages 2 in one of the multiple cartridges 10 and smooth removal of one of the multiple medicine packages 2 can be achieved.

As illustrated in FIG. 5A, the types of the multiple medicine packages 2 in one of the multiple cartridges 10 are sorted or divided based on the timings at which medicines are taken. For example, one cartridge contains medicines to be taken in fourteen days in the morning by Mr. or Ms. A. In view of the above circumstances, if Mr. or Ms. A takes the medicines not only in the morning but also in the daytime or in the evening, or before going to bed, four cartridges 10 are required in total.

However, no limitation is indicated thereby. For example, in an alternative embodiment of the present disclosure, a single cartridge 10 may be prepared for each person or patient who takes medicines. In such cases, for example, a pack to be used in the morning on day one, a pack to be used at lunchtime on day one, a pack to be used in the evening on day one, a pack to be used before going to bed on day one, a pack to be used in the morning on day two, a pack to be used at lunchtime on day two, and a pack to be used in the evening on day two may be stored in the order listed upward from the pack pickup slot 17 parallel to the direction in which packs are taken out from the multiple cartridges 10.

In the present embodiment, the right support portion 12 and the left support portion 13 are fixed to the interior wall 1le of the pack pickup slot 17 of the casing 11 such that one of the multiple medicine packages 2 can be picked up in a stable manner from one of the multiple cartridges 10 by the carriage 50.

In other words, the right support portion 12 and the left support portion 13 are fixed when the right support portion 12 and the left support portion 13 hold both ends of the medicine pack such as the medicine package 2 or the bound medicine packages 2A around the pack pickup slot 17 arranged at the lower portion of one of the multiple cartridges 10.

The medicine package 2 that is stored in the cartridge 10 is supported by a right support portion 12 and a left support portion 13 so as not to drop. The right support portion 12 supports a right end where the medicine package 2 is sucked up, and the left support portion 13 supports a left end on the other side.

The right support portion 12 and the left support portion 13 are different in the length of the portion that support the multiple medicine packages 2, and the length of portion of the right support portion 12 that support the multiple medicine packages 2 is shorter than that of the left support portion 13. As will be described later in detail with reference to FIG. 8A and FIG. 8B, when the lowermost one of the multiple medicine packages 2 stored in the cartridge 10 is adsorbed or sucked by the pair of suction pads 52 and is pulled out from the cartridge 10, the medicine pack is bent due to its elasticity. Accordingly, the medicine pack can easily be pulled out.

As the pair of support portions including the right support portion 12 and the left support portion 13 are of fixed type, the front end of the next one of the multiple medicine packages 2 to be taken out can be reliably held and does not jump out or fall off together with one of the multiple medicine packages 2 that is being taken out. As the pair of support portions including the right support portion 12 and the left support portion 13 do not swing or rotate, the medicine package 2 are held with high stability with no deformation or the like due to unintentional nipping or pressing in the returning operation.

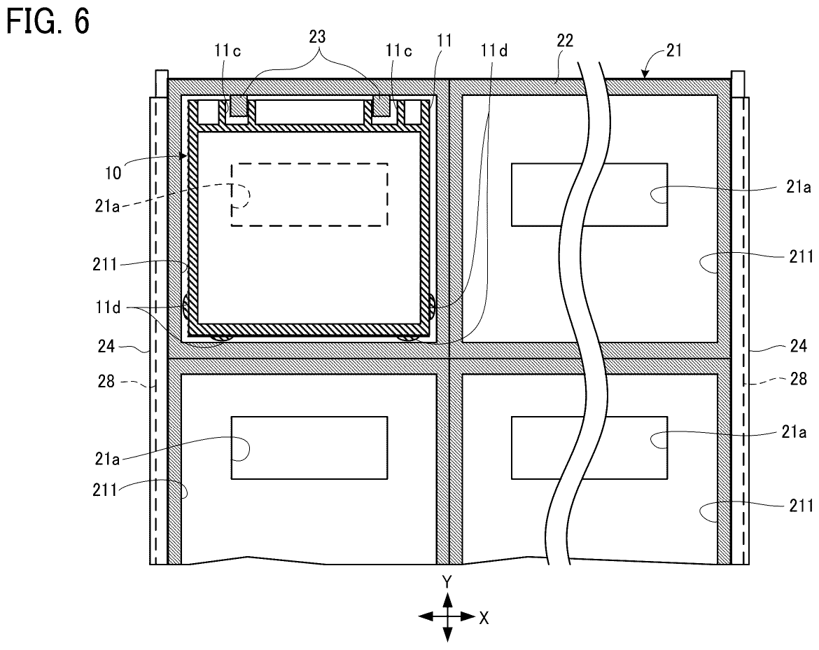

The attaching and detaching mechanisms and operations of the multiple containers that are arranged in the drawer 21 are described below with reference to FIG. 6 and FIG. 7. FIG. 6 is a schematic plan sectional view of the attaching and detaching mechanisms for the container, which are arranged on the drawer 21.

FIG. 7 is a schematic plan view of containers and illustrates the mechanisms for recognizing each one of the containers, which are arranged in the drawer 21.

As illustrated in FIG. 6, multiple cartridges 10 can be attached to or detached from the drawer 21. The casing 22 of the drawer 21 is provided with a pair of slide rails 24 on the right and left outer side walls, respectively, and the pair of slide rails 24 are slidable with a pair of rails 28 provided for the housing 199 (see FIG. 1A and FIG. 1B). Due to such a configuration, the drawer 21 can be attached or detached by being pulled out from the housing 199 (see FIG. 1A and FIG. 1B) through the engagement between the pair of slide rails 24 and the rails 28 of the housing 199.

As illustrated in FIG. 6, the cartridge 10 is attached to and detached from the drawer 21 through the engagement and disengagement between a pair of concave portions 11c on the external wall of the casing 11 of the cartridge 10 and a pair of convex portions 23 that are formed on the inner wall of the casing 22 of the drawer 21 and protrude inwardly and the engagement and disengagement between the inner wall of the casing 22 and four hemispherical protrusions 11d on the external wall of the casing 11. With the above-described attaching and detaching mechanism of the drawer 21, the multiple cartridges 10 can be attached or detached easily and with good operability.

In the above embodiments of the present disclosure, attachment and detachment are enabled by the coupling or engagement of concave and convex portions. However, no limitation is intended thereby, and an elastic member may be arranged in the gap between the inner wall of the casing 22 and the external wall of the casing 11 to enable attachment and detachment. Alternatively, a configuration or structure using magnetic force or a snap-fit assembly method may enable attachment and detachment.

As illustrated in FIG. 7, the drawer 21 has multiple containers 211 in which twenty cartridges 10 are stored. Each of the containers 211 has four columns of A to D in the horizontal direction, and has five rows of 1 to 5 in the vertical direction. The drawer 21 has a grip 26 that is held by hand to insert or withdraw the drawer 21, and information display devices such as light-emitting diodes (LEDs) 25a1 to 25d5 are arranged near the grip. Due to such a configuration, the arrangement of the multiple cartridges 10 can easily be figured out. More specifically, due to such a configuration, at what position the cartridge 10 in focus is placed in the drawer 21 can easily be figured out at a glance. In FIG. 6, the light-emitting diode (LED) 25a1 is used to detect the presence or absence of one of the multiple cartridges 10 attached to or detached from a container A1 of the drawer 21. The container A1 indicates an area or partition that is uniquely determined in the vertical columns and horizontal rows. In a similar manner to the above, the LED 25a2 corresponds to a portion of the storage unit A2 of the drawer 21, and the LED 25a3 corresponds to a portion of the storage unit A3 of the drawer 21. Moreover, the LED 25a4 corresponds to a portion of the storage unit A4 of the drawer 21, and the LED 25a5 corresponds to a portion of the storage unit A5 of the drawer 21. In a similar manner to the above, as illustrated in FIG. 7, each one of three columns of B to D and five rows of 1 to 5 of the multiple containers is provided with an LED that indicates whether one of the multiple cartridges 10, which is attached to and detached from one of the multiple containers, is present. When a plurality of information display devices such as the multiple LEDs 25a1 to 25d5 are used, for example, a staff who is an operator to attach one of the multiple cartridges 10 to one of the multiple containers 211 may mistake the lighting portion of the LEDs 25a1 to 25d5. In such cases, the cartridge 10 may erroneously attached to a wrong container other than desired one of the multiple containers 211. In order to handle such a situation, for example, whether the cartridge 10 is present may electrically or automatically be recognized by arranging a plurality of detection units such as sensors or switches at the multiple containers 211 in place of multiple information display devices such as the multiple LEDs 25a1 to 25d5.

The container may be provided with for example, a number, a bar code, a quick response code (QR CODE), or a non-contact integrated circuit (IC) tag such that each one of the containers will be identifiable. It is desired that the system be programmed to remember what container stores whose medicines. Subsequently, the drawer 21 to which the multiple containers are attached is set in the housing 199 of the medication support device 200, and each one of the multiple containers is identified by the medication support device 200. Due to such a configuration, a desired pack can be picked up in the medication support device 200 without causing any errors.

FIG. 8A is a front view of the carriage 50, illustrating a schematic configuration or structure of the carriage 50.

FIG. 8B is a plan view of the carriage 50 of FIG. 8A.

As illustrated in FIG. 8A and FIG. 8B, the carriage 50 includes a suction device 51 that is an example of a suction unit to pick up and holds one of the multiple medicine packages 2 from one of the multiple cartridges 10. The suction device 51 that is an example of the suction unit has a function to such up and separate the medicine package 2. When the medicine package 2 is to be sucked up, the suction device 51 has a function to suck up the medicine package 2 using the air under negative pressure generated by the negative-pressure generator 45 that serves as a switching unit between positive pressure and negative pressure. As will be described later in detail, the suction device 51 has a function to separate the medicine package 2 using the pressurized air generated by the negative-pressure generator 45 when the medicine package 2 is to be separated under normal operating conditions. The carriage 50 may have a function to make the suction device 51 open to the air to separate the medicine package 2.

As illustrated in FIG. 8A, the suction device 51 as described above sucks up one of the multiple medicine packages 2 as the negative-pressure generator 45 transforms the positive pressure generated by an air compressor 46 that serves as an air compressing means into negative pressure. The air compressor 46 is installed outside the conveyor 90, and is coupled to the suction device 51 through the air tank 47 and the negative-pressure generator 45 by a member for communication such as an air duct 49.

The air duct 49 is arranged together with, for example, a CABLEVEYOR and a wire harness so as not to be stretched even when the carriage 50 moves inside the medication support device 200. In other words, as illustrated in FIG. 1A and FIG. 1B, the air duct 49 has a one-turn path for each one of the X-axis, the Y-axis, and the Z-axis. Firstly, the air duct 49 is extended from the negative-pressure generator 45 in the Z-axis direction, and makes one turn. Secondly, the air duct 49 is extended in the X-axis direction, and makes one turn. Finally, the air duct 49 is extended in the Y-axis direction and makes one turn, and is coupled to the suction device 51.

The suction device 51 includes a pair of suction pads 52 that suck one of the multiple medicine packages 2, and a suction duct 53 coupled to the pair of suction pads 52. The negative-pressure generator 45 is also called a vacuum ejector valve and communicates with the suction duct 53 through the air duct 49. Each of the pair of suction pads 52 serves as an air suction unit or a suction member that sucks up and picks up one of the multiple medicine packages 2 in one of the multiple cartridges 10.

As described above, the upper ends of the pair of suction pads 52 as illustrated in FIG. 8A is arranged to absorb one of the multiple medicine packages 2. The bottom ends of the pair of suction pads 52 as illustrated in FIG. 8A is attached and fixed to the upper end of the suction duct 53 as illustrated in FIG. 8A. The bottom end of the suction duct 53 as illustrated in FIG. 8A is attached and fixed to the suction-pad supporting member 54. A pair of suction pads 52 and suction ducts 53 are arranged in the Y-axis direction.

The carriage 50 is provided with a posture changing unit used to change the posture of one of the multiple medicine packages 2 picked up from one of the multiple cartridges 10 to a substantially vertical posture. The posture changing unit in the carriage 50 includes, for example, a suction-pad supporting member 54 coupled to a suction device base 57 through a rotary shaft 55, a guide unit 59 that is an example of a suction-device guide formed with a guide groove 59b having a specific shape, a guide axis 56 that is fitted into the guide groove 59b of the guide unit 59 to guide the suction-pad supporting member 54, and a suction-device lifting and lowering unit.

The suction-pad supporting member 54 is coupled to the suction device base 57 through the rotary shaft 55. The suction-pad supporting member 54 may be may rotatably or pivotably be arranged around the rotary shaft 55 fixed to the suction-pad supporting member 54 within a range of a predetermined angle. Alternatively, the suction-pad supporting member 54 may be may rotatably or pivotably be arranged around the rotary shaft 55 fixed to the suction device base 57. In other words, in FIG. 8A and FIG. 8B, the distance between the center of the rotary shaft 55 and the center of a guide rod 58 in the X-axis direction, as will be described later in detail, is kept constant when the suction device base 57 moves along the guide rod 58 in up and down directions Z.

The suction-device lifting and lowering unit includes a pair of guide rods 58 that are arranged in the Y-axis direction to guide the suction device base 57 in the Z-axis direction, an endless belt 62 looped around a driving pulley 60 and a driven pulley 61, and a drive motor 63 coupled to the driving pulley 60 through a driving power conveyor such a gear or a belt. The drive motor 63 is an example of a driver circuit or driving source of the suction-device lifting and lowering unit.

The suction device base 57 is coupled and fixed to the endless belt 62 at a belt grip 62a fixed to the right end of the suction device base 57.

The pair of guide rods 58 are arranged at two different positions in the Y-axis direction, and extend in the Z-axis direction. The bottom ends of those guide rods 58 are fixed to the base frame 50b of the carriage frame 50a provided for the carriage 50.

A pair of guiding holes 57a into which the pair of guide rods 58 are inserted are formed around a right end of the suction device base 57.

The pulley axis of each one of the driving pulley 60 and the driven pulley 61 is rotatably supported by an immovable member on the carriage frame 50a. The drive motor 63 is fixed to an immovable member provided for the carriage frame 50a of the carriage 50. The drive motor 63 is also a driver circuit to be controlled of the suction unit lifting and lowering unit.

When the suction device base 57 is lifted or lowered by the operation of the drive motor 63, the suction device base 57 is moved along the pair of guide rods 58 in the Z-axis direction. Accordingly, the posture of the suction device base 57 on the XY plane can be kept constant in a substantially horizontal state.

The suction unit lifting and lowering unit is not limited to the above-described up-and-down reciprocating mechanism driven by a belt. Alternatively, for example, the suction unit lifting and lowering unit may have a reciprocating linear motion mechanism using a rack and pinion.

A pair of guide units 59 are arranged on both sides of the suction device 51 in the Y-axis direction across the suction-pad supporting member 54, and the bottom end of the guide unit 59 is fixed to the base frame 50b.

The guide axis 56 is arranged at both ends of the suction-pad supporting member 54 in the Y-axis direction so as to protrude, and is consistently fitted into the guide groove 59b of the guide unit 59 to guide the suction-pad supporting member 54, and a suction pad lifting and lowering unit. As illustrated in FIG. 8A, the guide axis 56 is arranged under the rotary shaft 55 of the suction-pad supporting member 54 in the Z-axis direction, at a certain distance from the rotary shaft 55.

When the suction device base 57 is moved in the Z-axis direction by the operation of the drive motor 63, the guide axis 56 of the suction-pad supporting member 54 is moved in the Z-axis direction parallel to the guide groove 59b having a specific shape while maintaining the posture of the suction device base 57 on the XY plane constant in a substantially horizontal state. Due to such a configuration, the posture of the pair of suction pads 52 can be rotated by approximately 90 degrees. In FIG. 8A, the suction device 51 that is rotated by approximately 90 degrees is indicated by thick broken lines. In the present embodiment, the expression “substantially horizontal state” indicates that the posture of a particular element is within a specific range of tolerance for angle with respect to the horizontal in addition to a state in which the position of a particular element is horizontal.

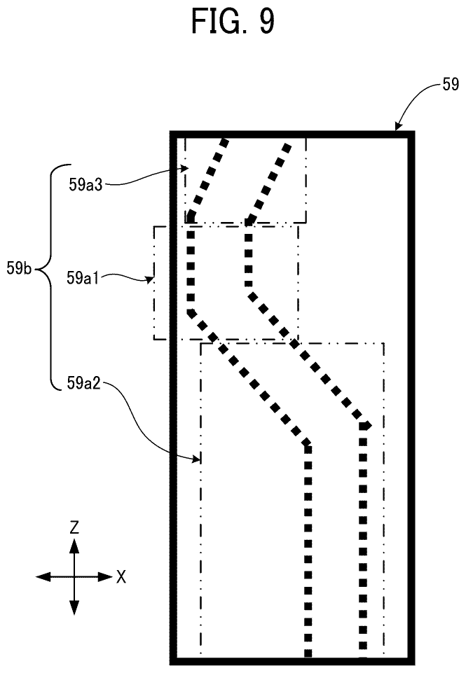

FIG. 9 is a magnified view of the guide groove 59b on the guide unit 59 provided for the carriage 50. As the guide axis 56 is guided to the first guide groove 59a1, the second guide groove 59a2, and the third guide groove 59a3, the guide grooves 59b each of which has a specific shape and is formed on the guide unit 59 holds the posture of the pair of suction pads 52 in a predetermined direction through the suction-pad supporting member 54 as illustrated in FIG. 8A.

The guide grooves 59b includes the first guide groove 59a1 in which the suction device base 57 can move with approximately horizontal posture when each of the pair of suction pads 52 move from its standby position to a pack-sucking position, the second guide groove 59a2 that gradually moves to the right side as it goes downward to rotate the posture of the suction-pad supporting member 54 and the pair of suction pads 52 by approximately 90 degrees, and the third guide groove 59a3 that communicates with and is connected to the top end of the first guide groove 59a1 and gradually moves to the right side as it goes upward to rotate the posture of the suction-pad supporting member 54 and the pair of suction pads 52 to the left. The first guide groove 59a1 and the second guide groove 59a2 communicate with each other and are coupled to each other.

The first guide groove 59a1 and the second guide groove 59a2 that are formed on the guide unit 59 to change the posture or attitude of the medicine package 2 picked up from the cartridge 10 from an approximately horizontal state in which the direction of the thickness of the medicine package 2 is substantially vertical to a substantially vertical posture is equivalent to posture changing unit.

The guide axis 56 and the third guide groove 59a3 of the guide grooves 59b each of which has a specific shape and is formed on the guide unit 59 make up an angle changing mechanism that changes the angle of the pair of suction pads 52 to a desired direction with respect to the medicine package 2 with the pair of suction pads 52 contacting the medicine package 2 at the bottom of the cartridge 10. The angle changing mechanism controls the pair of suction pads 52 when the pair of suction pads 52 suck one of the medicine packages 2, and makes the pair of suction pads 52 suck up one of the multiple medicine packages 2 in accordance with the inclination of the medicine package 2 at the bottom of the cartridge 10.

As will be described later in detail, when the pair of suction pads 52 rise toward the bottom of the cartridge 10, firstly, the pair of suction pads 52 and their suck-and-hold planes 52a enter the space under the cartridge 10 at an approximately horizontal angle, and then the angle of the pair of suction pads 52 with reference to one of the multiple medicine packages 2 at the bottom is changed depending on the extent to which the pair of suction pads 52 have entered the cartridge 10.

The above angle changing mechanism is provided with a mechanism including a link and slide guide. More specifically, the above angle changing mechanism includes a kind of link, which is a link member of the suction-pad supporting member 54 that guides the suction-pad supporting member 54 and connects the rotary shaft 55 and the guide axis 56 fitted into the guide groove 59b, and a slide guide, which is the guide grooves 59b including the third guide groove 59a3 on the guide unit 59A. The suction-pad supporting member 54 is a driven section coupled to the suction device base 57 that is a drive section and moves upward and downward through the rotary shaft 55.

As illustrated in FIG. 1A, FIG. 1B, and FIG. 8A, the carriage 50 is provided with the suction device 51 that is an example of a pickup device and uses the air. The carriage 50 is provided with an air tank 47, an air compressor 46, and a negative-pressure generator 45 to perform air suctioning, and those elements are coupled to each other by, for example, the air duct 49 or a joint used for piping.

In the medication support device 200, vacuum breakdown can be performed. As the negative-pressure generator 45 generates negative pressure by placing the air under negative pressure using the air compressed by the air compressor 46, the pack that contacts the pair of suction pads 52 of the suction device 51 with adhesion can be sucked and kept. On the contrary, the negative-pressure generator 45 may generate pressure to send out the air to the pair of suction pads 52 of the suction device 51. By so doing, the air discharges at the suck-and-hold planes 52a of the pair of suction pads 52, and the kept pack can be released.

Due to the relation between the guide groove 59b and the cross-axis distance between the rotary shaft 55 and the guide axis 56 as described above, the pair of suction pads 52 can take various kinds of posture by moving about the rotary shaft 55 that serves as a fulcrum. For example, the posture of the pair of suction pads 52 can be rotated by approximately 90 degrees.

The carriage 50 is provided with a posture changing unit used to change the posture of one of the multiple medicine packages 2 picked up from one of the multiple cartridges 10 to a substantially vertical posture. The posture changing unit in the carriage 50 includes, for example, a suction-pad supporting member 54 coupled to a suction device base 57 through a rotary shaft 55, a guide unit 59 that is an example of a suction-device guide formed with a guide groove 59b having a specific shape, a guide axis 56 that is fitted into the guide groove 59b of the guide unit 59 to guide the suction-pad supporting member 54, and a suction-device lifting and lowering unit.

The suction-pad supporting member 54 is coupled to the suction device base 57 through the rotary shaft 55. The suction-pad supporting member 54 may be may rotatably or pivotably be arranged around the rotary shaft 55 fixed to the suction-pad supporting member 54 within a range of a predetermined angle. Alternatively, the suction-pad supporting member 54 may be may rotatably or pivotably be arranged around the rotary shaft 55 fixed to the suction device base 57. In other words, in FIG. 8A and FIG. 8B, the distance between the center of the rotary shaft 55 and the center of a guide rod 58 in the X-axis direction, as will be described later in detail, is kept constant when the suction device base 57 moves along the guide rod 58 in up and down directions Z.

The suction-device lifting and lowering unit includes a pair of guide rods 58 that are arranged in the Y-axis direction to guide the suction device base 57 in the Z-axis direction, an endless belt 62 looped around a driving pulley 60 and a driven pulley 61, and a drive motor 63 coupled to the driving pulley 60 through a driving power conveyor such a gear or a belt. The drive motor 63 is an example of a driver circuit or driving source of the suction-device lifting and lowering unit.

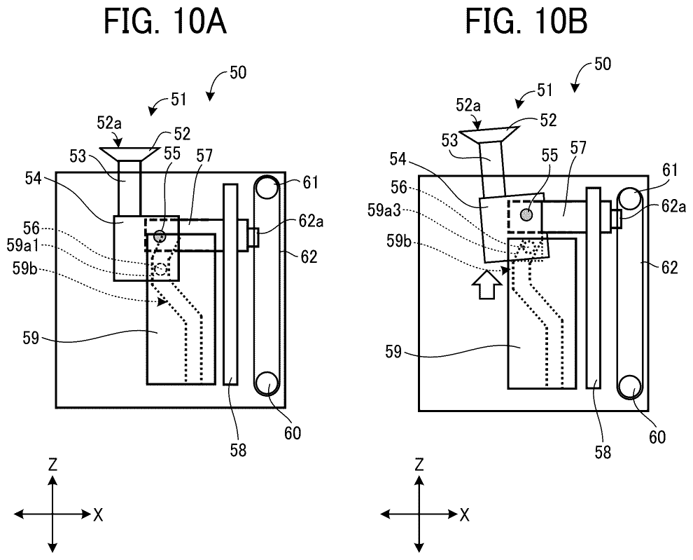

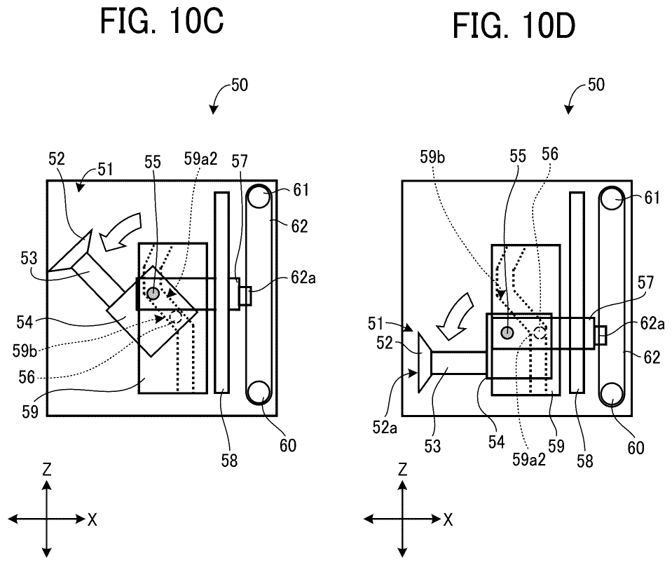

FIG. 10A to FIG. 10D are diagrams illustrating the progression of the posture-changing operations of the posture changing unit of the suction device 51.

As illustrated in FIG. 10A, when one of the medicine packages 2 is picked up from a position below the cartridge 10 illustrated in FIG. 5A, the suction duct 53 of the suction device 51 enters the cartridge 10 with an approximately vertical posture in the upward direction such that the suck-and-hold planes 52a of the pair of suction pads 52 will be approximately horizontal. In so doing, the guide axis 56 moves along the first guide groove 59a1.

Then, as illustrated in FIG. 10B, the endless belt 62 moves upward as the drive motor starts rotating. Accordingly, the suction device base 57 is lifted, and the suction-pad supporting member 54 rises. When the posture of the suction device 51 further changes accordingly, the guide axis 56 moves upward along the third guide groove 59a3, and the pair of suction pads 52 of the suction device 51 are slightly inclined toward the left. With such a posture, the suction device 51 sucks up and picks up a pack from a position below the cartridge 10.

When the pack has been taken out from a position below the cartridge 10 as illustrated in FIG. 10C, the drive motor 63 turns in the reversed manner and the endless belt 62 moves downward. As a result, the suction-pad supporting member 54 rotates around the rotary shaft 55 of the suction device base 57 in a counterclockwise direction of FIG. 10C, while the suction device base 57 is moving downward.

Then, as illustrated in FIG. 10D, the suction device base 57 moves further downward and the suction-pad supporting member 54 rotates around the rotary shaft 55 of the suction device base 57 in a counterclockwise direction of FIG. 10D. Together with the suction device base 57, the guide axis 56 rotates around the rotary shaft 55 in a counterclockwise direction of FIG. 10D while being guided vertically downward along the second guide groove 59a2. The suck-and-hold planes 52a of the pair of suction pads 52 rotate by approximately 90 degrees in a counterclockwise direction from the state illustrated in FIG. 10A, and the rotary shaft 55 and the guide axis 56 are aligned horizontally in a straight line. In so doing, the guide axis 56 moves vertically downward along the second guide groove 59a2 and the suction device 51 rotates by approximately 90 degrees. As the suction holding of the pack is released with this posture, the pack is dispensed to a desired one of the subdivision boxes 34 (see FIG. 3).

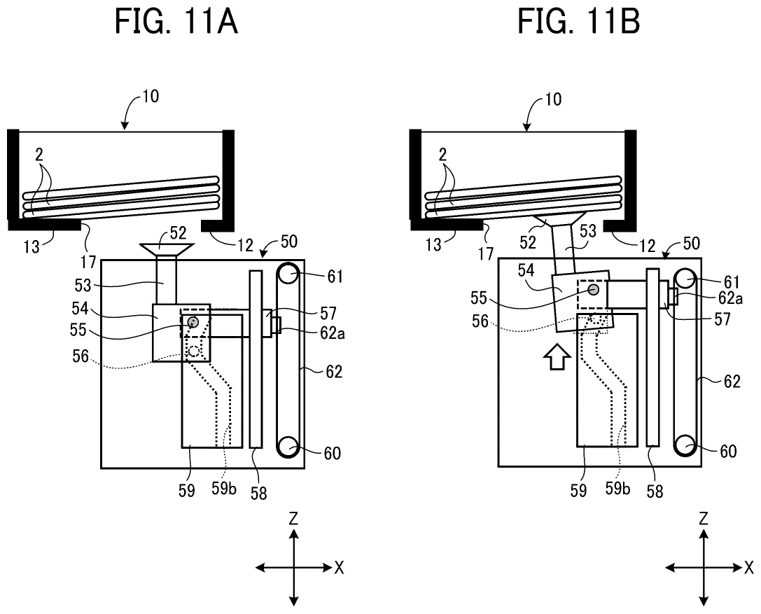

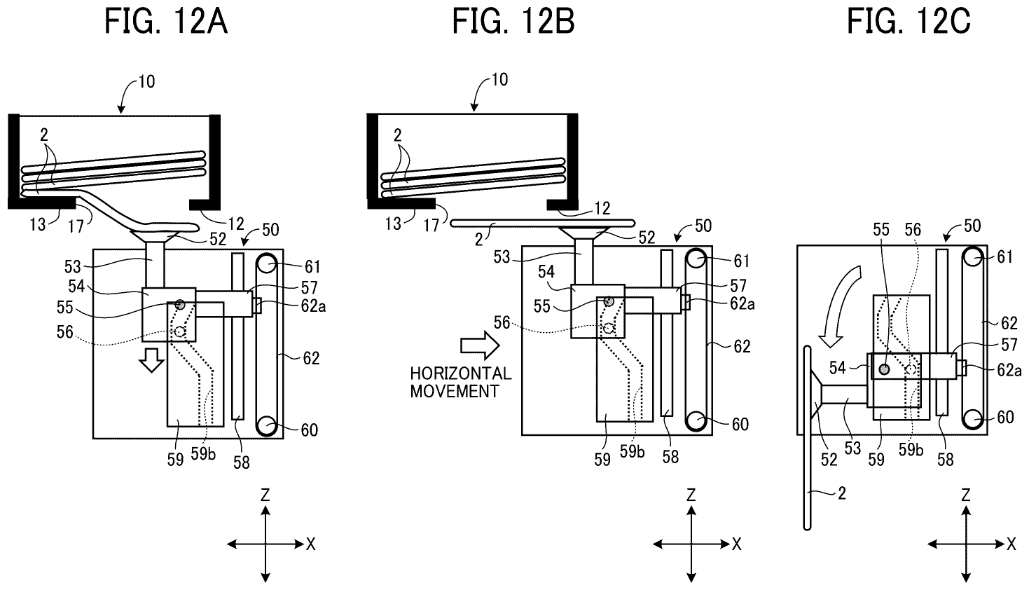

FIG. 11A to FIG. 12C are front views of the carriage 50, illustrating the series of progression of the operation of the carriage 50.

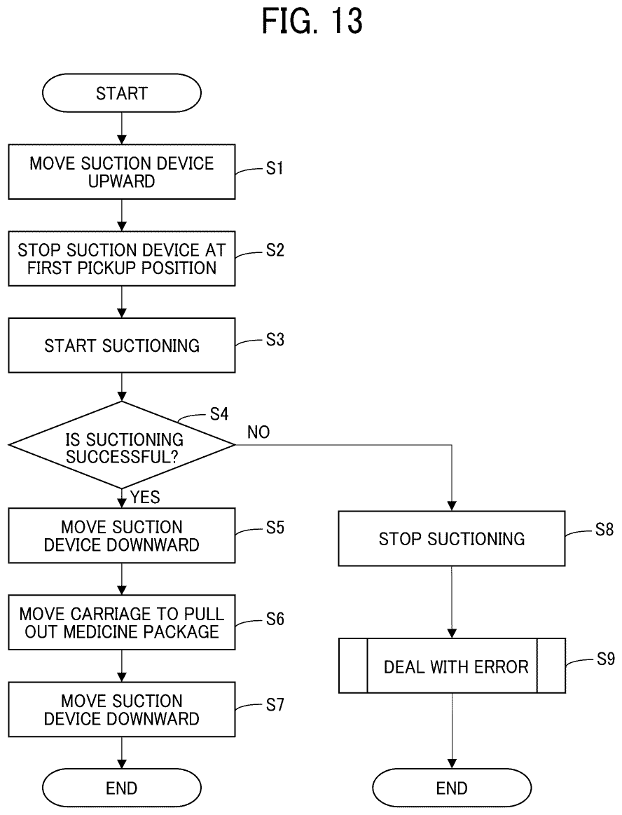

FIG. 13 is a flowchart of the series of operation of the carriage 50.

The flow of a picking-out operation in which desired one of the multiple medicine packages 2 is picked up from one of the multiple cartridges 10 is described with reference to FIG. 11A to FIG. 13. The shape and state of the medicine package 2 stored in the cartridge 10 are schematically illustrated in a similar manner to the illustration in FIG. 5A. The positions of the medicine package 2 that are sucked by the pair of suction pads 52 at the bottom of the cartridge 10 are indicated by dot-dot-dash lines in FIG. 5B.

For the sake of explanatory convenience, it is assumed in the present embodiment that, due to the operation of the conveyor 90 illustrated in FIG. 1A and FIG. 1B, the carriage 50 is arranged below the cartridge 10 provided for one of the drawers 21 arranged at the central portion of the housing 199 illustrated in FIG. 1A and FIG. 1B. After the pair of suction pads 52 of the carriage 50 sucks and pulls out the lowermost pack in the cartridge 10, as the conveyor 90 operates, the carriage 50 moves above the medicine dispensing tray 30, which is placed uppermost in FIG. 1A and FIG. 1B. Then, the carriage 50 drops and insert the pack into the subdivision box 34 of specific one of the rooms 33 of the medicine dispensing tray 30.

For the sake of explanatory convenience in relation to the above description with reference to FIG. 8A and FIG. 8B, it is assumed in the present embodiment that the right support portion 12 and the left support portion 13, which are formed at the bottom of the cartridge 10, whose cross sections are indicated by a solid fill in black are made of suitable resin and formed as a single integrated unit. The same applies to the casing 11 of the cartridge 10. For the sake of explanatory convenience, in FIG. 11A to FIG. 12C, the rotary shaft 55 and the guide axis 56 are indicated by a solid line in gray and a broken line, respectively.

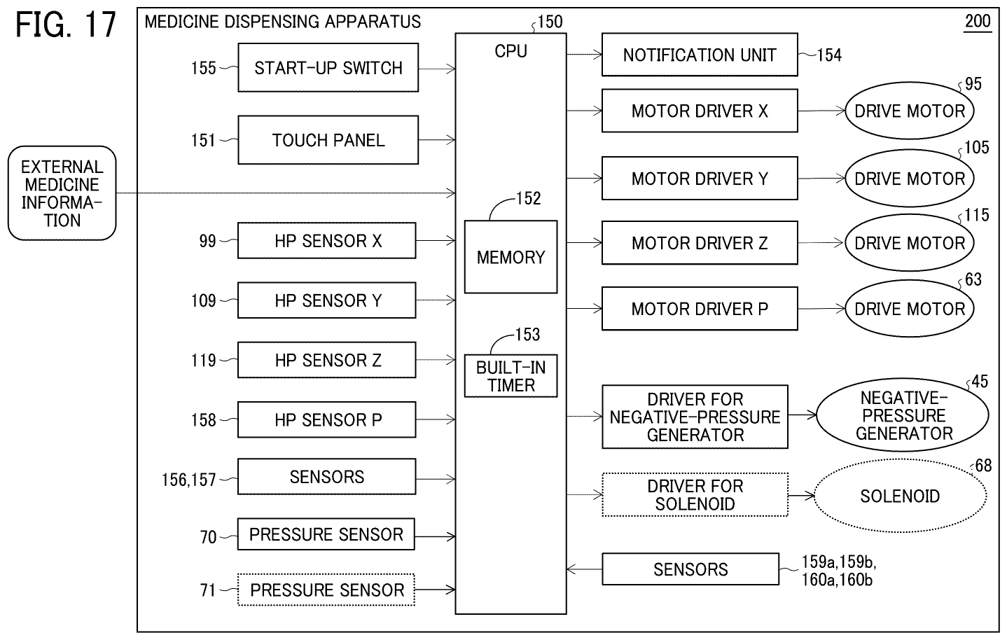

Once the medicine dispensing operation starts, under the control commands from the CPU that is described later in detail in FIG. 17 and makes up the controller 150, the carriage 50 moves to a position under the cartridge 10 by the conveying operation of the conveyor 90 illustrated in FIG. 1A and FIG. 1B, stops moving, and goes on standby based on the identification data that is applied to the cartridge 10, in order to pick up desired one of the medicine packages 2. At that moment in time, the drive motor 63 stops its operation, and the suck-and-hold planes 52a of the pair of suction pads 52 takes an approximately vertical or upright posture.

Subsequently, as illustrated in FIG. 11A, the drive motor 63 starts operating, and in step S1, the suction device base 57 and the pair of suction pads 52 move upward in a straight line through the coupling between the suction device base 57 that linearly moves and the suction-pad supporting member 54 that linearly and rotationally moves. In so doing, the pair of suction pads 52 enter from the pack pickup slot 17 between the right support portion 12 and the left support portion 13 after the suck-and-hold planes 52a of the pair of suction pads 52 changes its posture from an approximately vertical or upright posture to an approximately horizontal posture. In so doing, in step S2, the drive motor 63 is controlled and stops its operation such that the pair of suction pads 52 of the suction device 51 stop moving at the first pickup position in the posture obliquely inclined toward the left as illustrated in FIG. 10B. When the suction device 51 pauses, the negative-pressure generator 45 (see FIG. 8A and FIG. 8B) is driven to enable sucking operation. As soon as the pair of suction pads 52 contact the medicine package 2, in step S3, suctioning on the medicine package 2 starts by the negative pressure generated by the negative-pressure generator 45 illustrated in FIG. 8A

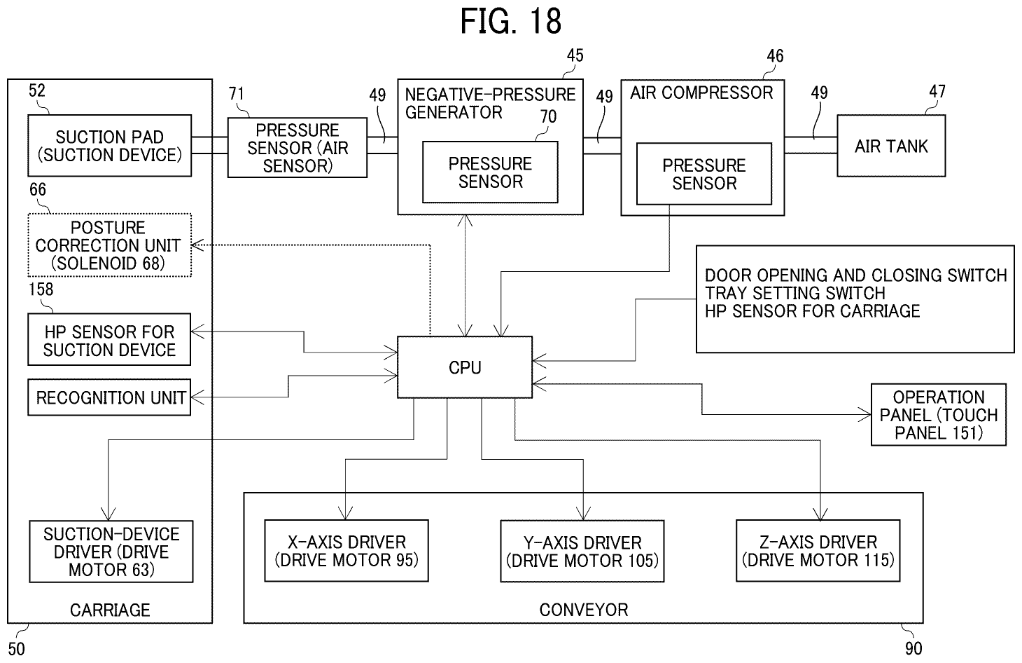

Subsequently, the process proceeds to step S4, and whether the suctioning is successful is determined. More specifically, whether the negative pressure generated by the negative-pressure generator 45 has an appropriate value to pick up the medicine package 2 from the cartridge 10 by maintaining the negative pressure using the pair of suction pads 52 is checked. In other words, the CPU of the controller 150 as will be described later in detail with reference to FIG. 17 and FIG. 18 determines whether the value detected by the pressure sensor 70 arranged inside the negative-pressure generator 45 or the pressure sensor 71 provided for the air duct 49 between the negative-pressure generator 45 and the pair of suction pads 52 as illustrated in FIG. 8A is appropriate. When it is determined that the medicine package 2 is successfully sucked up by the pair of suction pads 52 (YES in step S4), in step S5, the suction device 51 moves downward by the reverse operation of the drive motor 63 while maintaining the negative pressure on the medicine package 2 by the pair of suction pads 52 as illustrated in FIG. 12A. The front end of one of the medicine packages 2 is pulled out from one of the multiple cartridges 10. The front end of the medicine package indicates a side of the medicine package to be absorbed or sucked up by the pair of suction pads 52, and the same applies in the following description. The operation of pulling out the front end of one of the multiple medicine packages 2 from the pack pickup slot 17 of one of the multiple cartridges 10 under such conditions can be done without causing any sort of problem as the pulled-out medicine package 2 can deform freely.

Then, as illustrated in FIG. 12B, in step S6, by the operation of the conveyor 90 (see FIG. 1A and FIG. 1B), the carriage 50 is moved in the X-axis direction, which is the lateral or horizontal direction, and the rear end of one of the multiple medicine packages 2 is drawn out or picked up from one of the multiple cartridges 10. Subsequently, as illustrated in FIG. 12C, by the operation of the drive motor 63, one of the multiple medicine packages 2, which is approximately in a horizontal state and is sucked and held by the pair of suction pads 52, is rotated by substantially 90 degrees to change the posture to an approximately vertical or upright posture. In so doing, when the suction device base 57 moves downward linearly along the guide rod 58 as the drive motor 63 is driven to rotate, the guide axis 56 moves along the shape of the guide groove 59b of the guide unit 59, and the relative positions of the rotary shaft 55 and the guide axis 56 change. Accordingly, the posture of one of the multiple medicine packages 2 can be changed from an approximately horizontal posture to an approximately vertical posture. As a result, one of the multiple medicine packages 2 is kept upright such that the thickness direction of that medicine package 2 is substantially horizontal.

In other words, the guide axis 56 is moved away from the trajectory followed by the rotary shaft 55 along the shape of the guide groove 59b of the guide unit 59, by the cross-axis distance between the rotary shaft 55 and the guide axis 56, to rotate the pair of suction pads 52 by approximately 90 degrees (see step S9). The above series of operation in the above configuration may be achieved by a series of operations performed by a single drive motor 63.

On the other hand, when suctioning of the medicine package 2 by the pair of suction pads 52 is not successful (NO in step S4), in step S8, the generation of negative pressure by the negative-pressure generator 45 and suctioning are stopped, and in step S9, a user such as a nurse practitioner or a care manager deals with an error as specified. Such handling by a user includes, for example, dealing with the medicine package 2 whose pickup from the cartridge 10 was not successful and diagnosing the cause of a problem. Then, this series of processes is terminated.

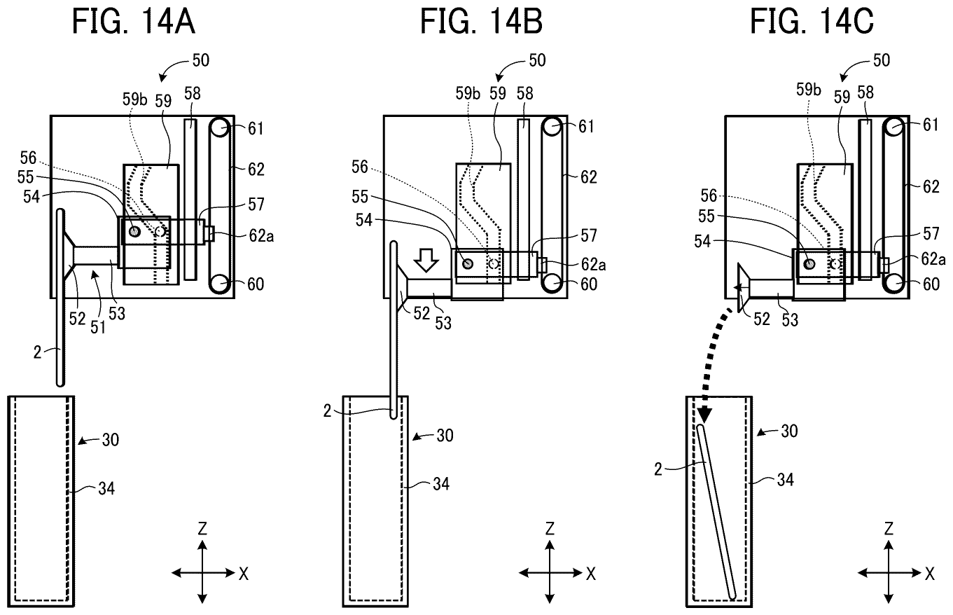

With reference to FIG. 14A, FIG. 14B, and FIG. 14C, a placing operation in which the medicine package 2 is dispensed to a desired one of the subdivision boxes 34 of the medicine dispensing tray 30 is described below. FIG. 14A, FIG. 14B, and FIG. 14C illustrate cases in which the medicine dispensing operation is successfully completed as in, for example, FIG. 3 by a placing operation in which the medicine package 2 is dispensed to a desired one of the subdivision boxes 34 of the medicine dispensing tray 30. However, no limitation is intended thereby, as illustrated in, for example, FIG. 4, the medicine dispensing operation may be completed by a placing operation in which desired one of the medicine packages 2 is dispensed to a desired one of the rooms 33 of the medicine dispensing tray 30 without involving the subdivision boxes 34.

After the above picking-out operation is completed, the carriage 50 is moved by the conveyor 90 (see FIG. 1A and FIG. 1B) to a position above a desired one of the rooms 33 or the subdivision boxes 34 of the medicine dispensing tray 30 while the pair of suction pads 52 are sucking and holding the medicine package 2 vertically (see, for example, FIG. 14A). During such movement, the position of the carriage 50 in the Z-axis direction and the height direction is designed such that the bottom end of the medicine package 2 held by the pair of suction pads 52 does not contact the subdivision boxes 34.

In so doing, as illustrated in FIG. 14B, it is desired that the bottom edge of the medicine package 2 be inserted into the subdivision box 34 by lowering the suction device base 57, the suction-pad supporting member 54, and the pair of suction pads 52 in its entirety. In the placing operation, the holding of the pack is released after the bottom edge of the medicine package 2 is inserted into the subdivision box 34. Due to such a configuration, the medicine packages 2 is prevented from being dispensed to another one of the subdivision boxes 34 other than desired one of the subdivision boxes when the pack is dropped and rotated or flicked. If the degree of insertion into the subdivision box 34 is small, the bottom edge of the medicine package 2 is caught by the top edge of the subdivision box 34 when the medicine package 2 drops, and there are some cases in which the medicine package 2 is not dispensed to the subdivision box 34. In order to avoid such a situation, it is desired in the picking-out operation that a portion of the medicine package 2 near its top edge be sucked and held to take it out.

As illustrated in FIG. 14B and FIG. 14C, when the negative-pressure generator 45 (see FIG. 8A) is driven to generate positive pressure to send the air to the pair of suction pads 52 for prescribed length of time and the holding of the medicine package 2 is released, the medicine package 2 drops by its own weight. An operation in which the air that is generated by positive pressure is sent out to the pair of suction pads 52 that suck and hold the medicine package 2 by air and the suction holding of the pack is released is referred to as vacuum breakdown in the following description. When the medicine package 2 is stored in the subdivision box 34, it is determined that the medicine dispensing operation or the placing operation is complete and the process proceeds to the next operation.

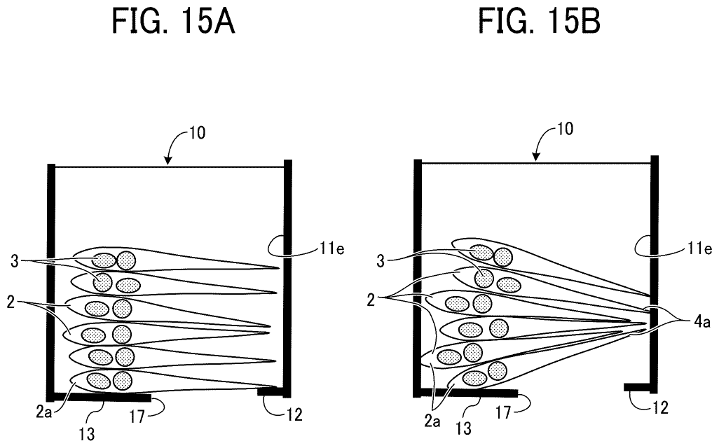

FIG. 15A and FIG. 15B are diagrams illustrating a case in which the front edges of the medicine packages 2 are caught by a side face of the cartridge 10 and are inclined at an oblique angle.

In those drawings, the medicine packages 2 whose shapes are closer to actual samples than the medicine packages 2 schematically illustrated in, for example, FIG. 5A and FIG. 5B are illustrated. As illustrated in FIG. 15A, the medicine packages 2 are stacked on top of each other inside the cartridge 10, and the entirety of the medicine package 2 at the lowermost position is dropped close to the bottom face of the cartridge 10. Under these conditions, the pair of suction pads 52 contact the medicine packages 2 with sufficient adhesion when the pair of suction pads 52 of the suction device 51 enter the cartridge 10, and suctioning can be done with reliability.

By contrast, as illustrated in FIG. 15B, there are some cases in which pressure-bonded ends 4a on the other side of the bags 2a where the medicines 3 of the medicine packages 2 gather are caught by an interior wall 1le of the cartridge 10 are inclined, depending on, for example, the type or size of the medicines 3 enclosed in the medicine packages 2 or the materials or shapes of the medicine packages 2. Under such conditions, even when the pair of suction pads 52 of the suction device 51 enter the cartridge 10, a clearance is left between the medicine package 2 and the suck-and-hold planes 52a of the pair of suction pads 52, and the pair of suction pads 52 do not contact the medicine packages 2 with sufficient adhesion. This disables successful suctioning.

The medicine package 2 is light in weight and low in rigidity. For this reason, even if the extent to which the suction device 51 enters the cartridge 10 is simply increased, there are some cases in which the medicine package 2 is pushed by the pair of suction pads 52 of the suction device 51 and is retracted upward. This disables successful suctioning. Moreover, there are some cases in which the conditions of the medicine packages 2 stacked on top of each other in the cartridge 10 get worse as the medicine packages 2 are pushed by the pair of suction pads 52 of the suction device 51. In order to deal with such a situation, it is desired that the posture or attitude of the pair of suction pads 52 of the suction device 51 be changed after the entry into the cartridge 10 to meet the inclination of the medicine package 2.

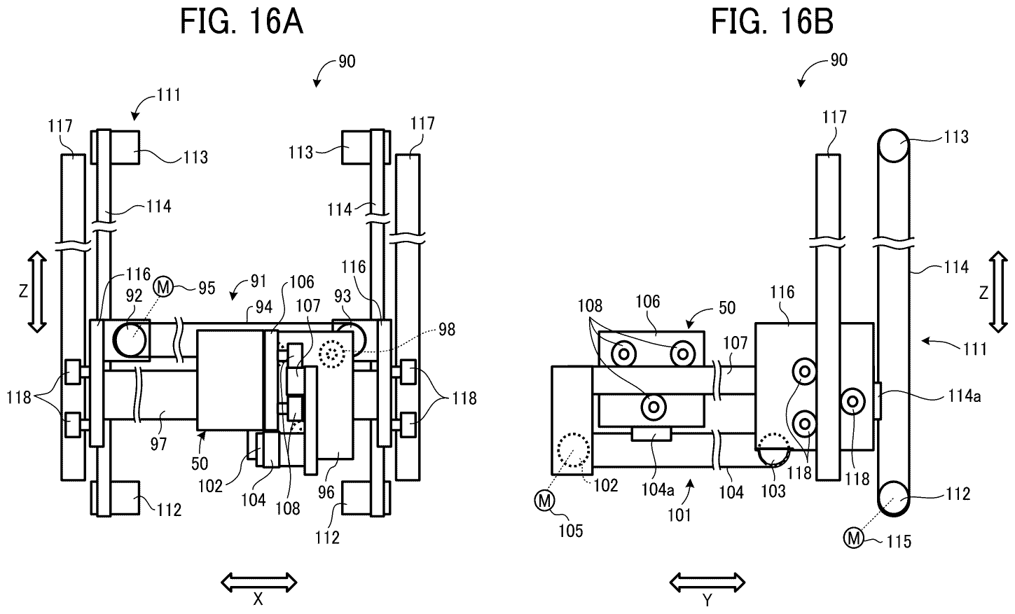

The configuration and operation of the conveyor 90 will be described with reference to FIG. 16A and FIG. 16B.

FIG. 16A is a front view of the conveyor 90, illustrating a schematic configuration of the conveyor 90.

FIG. 16B is a side view of the conveyor 90 of FIG. 16A.

As in the configuration or structure of the medication support device 200 illustrated in FIG. 1A and FIG. 1B, the multiple cartridges 10 are aligned in rows on planes below the medicine dispensing trays 30 in the Z-axis direction, and the medicine dispensing trays 30 are arranged above the cartridges 10. In view of these circumstances, the carriage 50 is moved in three directions of the X-axis direction, the Y-axis direction, and the Z-axis direction. As described above, the conveyor 90 moves the carriage 50 in the X-axis direction, the Y-axis direction, and the Z-axis direction in order to convey one of the multiple medicine packages 2 picked up from one of the multiple cartridges 10 by the carriage 50 and pass it to one of the multiple medicine dispensing trays 30.

The carriage 50 is moved in the X-axis direction by an X-axis direction conveyor 91, and the carriage 50 is moved in the Y-axis direction by a Y-axis direction conveyor 101. The carriage 50 is moved in the Z-axis direction by a Z-axis direction conveyor 111. These three conveyance units have a similar configuration or structure.

The X-axis direction conveyor 91 includes an X-adaptor 96 attached to the carriage 50, an X-guide unit 97 that guides the carriage 50 in the X-axis direction through the X-adaptor 96, an endless belt 94 looped around a driving pulley 92 and a driven pulley 93, and a drive motor 95 that is coupled to the driving pulley 92 through a driving force conveyor such as a gear or a belt and is used for the conveyance in the X-axis direction.

As illustrated in FIG. 16A, three rollers 98 are attached to the X-adaptor 96 so as to clamp the X-guide unit 97. Due to such a configuration, the X-adaptor 96 can roll over the X-guide unit 97. Note also that two of the three rollers 98 are hidden by the carriage 50 and invisible in FIG. 16A. The X-adaptor 96 is fixedly coupled to the endless belt 94 through a belt grip.

When the drive motor 95 is driven to rotate due to the above configuration or structure of the X-axis direction conveyor 91, the driving force is conveyed to the endless belt 94 through the driving force conveyor and the driving pulley 92, and the endless belt 94 runs in rotation. Accordingly, the carriage 50 moves in the X-axis direction along the X-guide unit 97 together with the X-adaptor 96.

The Y-axis direction conveyor 101 includes a Y-adaptor 106 attached to the carriage 50, a Y-guide unit 107 that guides the carriage 50 in the Y-axis direction through the Y-adaptor 106, an endless belt 104 looped around a driving pulley 102 and a driven pulley 103, and a drive motor 105 used for the conveyance in the Y-axis direction. The drive motor 105 is coupled to the driving pulley 102 through a driving force conveyor such as a gear or a belt.

Three rollers 108 are attached to the Y-adaptor 106 so as to clamp the Y-guide unit 107. Due to such a configuration, the Y-adaptor 106 can roll over the Y-guide unit 107. The Y-adaptor 106 is coupled and fixed to the endless belt 104 through the belt grip 104a.

When the drive motor 105 is driven to rotate due to the above configuration or structure of the Y-axis direction conveyor 101, the driving force is conveyed to the endless belt 104 through the driving force conveyor and the driving pulley 102, and the endless belt 104 runs in rotation. Accordingly, the carriage 50 moves in the Y-axis direction along the Y-guide unit 107 together with the Y-adaptor 106.

The Z-axis direction conveyor 111 includes a pair of Z-adaptors 116 attached to both ends of the X-guide unit 97 in the X-axis direction, a pair of Z-guide units 117 that guides the carriage 50 in the Z-axis direction through the X-guide unit 97 and the pair of Z-adaptors 116, an endless belt 114 looped around a driving pulley 112 and a driven pulley 113, and a drive motor 115 used for the conveyance in the Z-axis direction. The drive motor 115 is coupled to the driving pulley 112 through a driving force conveyor such as a gear or a belt.

In the Z-axis direction conveyor 111, the driving pulley 112, the driven pulley 113, and the endless belt 114 are arranged on both sides in the X-axis direction. The drive motor 115 is provided for only one of the pair of driving pulleys 112.

Three rollers 118 are attached to the Z-adaptor 116 so as to clamp the Z-guide unit 117. Due to such a configuration, the Z-adaptor 116 can roll over the Z-guide unit 117. The pair of Z-adaptors 116 are coupled and fixed to the pair of endless belts 114 through a pair of belt grips 114a, respectively.

When the drive motor 115 is driven to rotate due to the above configuration or structure of the Z-axis direction conveyor 111, the driving force is conveyed to the endless belt 114 through the driving force conveyor and the driving pulley 112, and the endless belt 114 runs in rotation. Accordingly, the carriage 50 moves in the Z-axis direction along Z-guide unit 117 together with the X-guide unit 97 and the Z-adaptor 116.

In FIG. 16A and FIG. 16B, the carriage 50 moves in the triaxial directions including the X-axis direction, the Y-axis direction, and the Z-axis direction. However, no limitation is indicated thereby. For example, when the cartridge 10 is arranged above the carriage 50 and the medicine dispensing tray 30 is arranged below the carriage 50, the carriage 50 only needs to move in the X-axis direction and the Y-axis direction. In such cases, the number of axes of motion can be reduced by one.

FIG. 17 is a block diagram illustrating a schematic control structure for the medication support device 200.

As illustrated in FIG. 17, the medication support device 200 includes a central processing unit (CPU) that serves as a controller 150 that controls the operation of, for example, the components or elements of the medication support device 200. For example, the CPU may be provided with a built-in memory 152 or a built-in timer 153.

The CPU according to the present embodiment may provide notification to, for example, a user including staff or the like at a timing consistent with the program or may instruct the medication support device 200 to perform particular operation, based on various kinds of input such as the inputs from a sensor as will be described later in detail. To the built-in memory 152, prescription data or medicine information are externally input as external medicine information.

The CPU may have, for example, a computing or control function, and a timer or clocking function. A memory 152 includes, for example, a read-only memory (ROM), a random access memory (RAM), and an external memory. The ROM according to the present embodiment stores, for example, a program readable by the above CPU and various kinds of data in advance. Such a program stored in the ROM may be a program used in the flowchart of the controlling processes as will be described later in detail. The above various kinds of data may be, for example, the data about the relation between the medicine packages 2 and the rooms 33 or the subdivision boxes 34 of one of the medicine dispensing trays 30 allocated to each of the patients who take medicines, the data about the relation between the medicine packages 2 and the multiple rooms 33 or the multiple subdivision boxes 34 of one of the medicine dispensing trays 30 assigned to each one of the times of medication, or the data about the relation between the medicine packages 2 and the rooms 33 or the subdivision boxes 34 of one of the medicine dispensing trays 30 sorted according to the order in which medicines are to be taken (see, for example, FIG. 3 or FIG. 4).

The CPU has an input and output (I/O) port, and a touch panel 151 that is an example of a user interface (UI) and an operation panel provided with an input unit and a display unit is electrically connected to that input and output port of the CPU.

Through the touch panel 151, various kinds of inputs can be made, and for example, the current time, the progress of the storing process of packs, or the stop time are displayed on the touch panel 151. How such inputs are made or the structure or configuration of such a display unit are not limited thereto, and may be, for example, an input unit and a display unit may be arranged separately. Alternatively, a combination of an input device and a display interface such as a combination of a keyboard and a light-emitting diode (LED) display may be adopted.

To the input port of the CPU, a start-up switch 155 that drives the medication support device 200 to operate is electrically connected. Once the start-up switch 155 is touched or pressed down, medicine dispensing operation to the medicine dispensing trays 30 starts step by step. The medicine dispensing operation to the medicine dispensing trays 30 may start at a time determined in advance by the built-in timer 153.

The CPU according to the present embodiment has an input port, and a medicine dispensing tray sensor 156 that detects the type of medicine dispensing tray 30 stored in the medication support device 200 or determines whether or not there is any medicine dispensing tray 30, and a container sensor 157 that determines whether or not there is any one of the multiple cartridges 10 are electrically connected to the input port of the CPU.

As various types of sensors, a pair of container gate opening and closing sensors 159a and 159b that detect the opening and closing of the first gate 41 and the second gate 42 and a pair of medicine dispensing tray gate opening and closing sensors 160a and 160b that detect the opening and closing of the third gate 43 and the fourth gate 44 are electrically connected to the input port of the CPU.

The medicine dispensing tray sensor 156, the container sensor 157, the pair of container gate opening and closing sensor 159a and 159b, and the pair of medicine dispensing tray gate opening and closing sensors 160a and 160b are illustrated in FIG. 17.

To the input port of the CPU, a HP sensor 99 for a HP sensor X, which detects the home position (HP) of the X-axis direction conveyor 91 in the carriage 50, a HP sensor 109 for a HP sensor Y, which detects the home position (HP) of the Y-axis direction conveyor 101 in the carriage 50, and a HP sensor 119 for a HP sensor Z, which detects the home position (HP) of the Z-axis direction conveyor 111 of the carriage 50 are electrically connected.

Further, to the input port of the CPU, a home position (HP) sensor 158 for a HP sensor P, which detects the home positions (HP) of the pair of suction pads 52 of the suction device 51 in the carriage 50 is electrically connected.

Further, to the input port of the CPU, the pressure sensor 70 that detects the pressure inside the negative-pressure generator 45 or the carriage 50 is electrically connected. The pressure sensor 71 that is surrounded by a broken line in FIG. 17 is adopted in the second example as will be described later in detail.

To the output port of the above CPU, the drive motor 95 for the X-axis direction conveyor 91, the drive motor 105 for the Y-axis direction conveyor 101, the drive motor 115 for the Z-axis direction conveyor 111, and the drive motor 63 used to change the posture or attitude of the pair of suction pads 52 are electrically connected to the input port of the CPU through various kinds of motor drivers X, Y, Z, and P, respectively.

Moreover, to the output port of the above CPU, the negative-pressure generator 45 that is an example as an ejector valve and an actuator used for the negative pressure generator is electrically connected through a driver used for a negative-pressure generator.

To the output port of the CPU, a notification unit may be electrically connected. Such a notification unit reports what sort of state or conditions the components or elements of the medication support device 200 are in by means of, for example, the light emitted from a light-emitting diode (LED) and the sound or vibration including voice. Moreover, such a notification unit may be provided with, for example, a loudspeaker or a light that indicates that the medicines are to be taken so that the staff or the like away from the medication support device 200 can be notified of such a time of medication.

The external medicine information is also input to the CPU through an input and output (I/O) interface, and is stored in the built-in memory 152. For example, the external medicine information is used for the allocation of medicines to patients who take medicines. For example, the LEDs 25a1 to 25d5 of the drawer 21 may be electrically connected to each other.

Once the input data from the touch panel 151 and various kinds of signals from various types of sensors or the HP sensors 99, 109, 119, and 158 are input to the CPU, a command signal is newly output from the CPU. In other words, the CPU according to the present embodiment outputs a command signal used to control the audio device or the optical device of the display device of the touch panel 151 including the above notification unit, the LEDs 25a1 to 25d5, the drive motor 63, the drive motor 95, the drive motor 105, the drive motor 115, or the multiple drives that correspond to the multiple LEDs.

The HP sensor 158 for the HP sensor P and the drive motor 63 that outputs power through the motor driver P are used to control or drive the mechanism for moving the suction device to move upward and downward.

The CPU according to the present embodiment executes various kinds of control operation as will be described later in detail in the following description or the flowchart of the controlling processes.

FIG. 18 is a diagram illustrating the control blocks of the medication support device 200, viewed from a different angle.

The pressure sensor 71, which is illustrated in FIG. 18 and arranged inside the air compressor 46, keeps the air pressure inside the air compressor 46 within a specific range.

As illustrated in FIG. 17 and FIG. 18, the conveyor 90 of the medication support device 200 according to the examples as will be described later in detail includes the drive motor 95 for the X-axis driver of the X-axis direction conveyor 91, the drive motor 105 for the Y-axis driver the Y-axis direction conveyor 101, and the drive motor 115 for the Z-axis driver the Z-axis direction conveyor 111. In the medication support device 200, the CPU controls each of the drive motors 95, 105, and 115 of the conveyor 90 based on the signals input from the HP sensors 99, 109, and 119 illustrated in FIG. 17 and the signals related to the numbers given to the cartridges 10 or the numbers given to the subdivision boxes 34 of the medicine dispensing tray 30, which are input through the touch panel 151 that is illustrated in FIG. 17 and is an example of the operation panel. Due to such a configuration, the carriage 50 can be moved to any position inside the housing 199. The same applies to the examples as will be described later in detail.

As illustrated in FIG. 1A, FIG. 1B, and FIG. 8A, the carriage 50 of the medication support device 200 is provided with the suction device 51 that is an example of a pickup device and uses the air. The carriage 50 is provided with an air tank 47, an air compressor 46, and a negative-pressure generator 45 to perform air suctioning, and those elements are coupled to each other by, for example, the air duct 49 or a joint used for piping.

As described above, in the medication support device 200 according to the examples, the negative-pressure generator 45 generates negative pressure by placing the air under negative pressure using the air compressed by the air compressor 46. By so doing, the pack that contacts the pair of suction pads 52 of the suction device 51 with adhesion can be sucked and kept. On the contrary, the negative-pressure generator 45 may generate pressure to send out the air to the pair of suction pads 52 of the suction device 51. By so doing, the air discharges at the suck-and-hold planes 52a of the pair of suction pads 52, and the kept pack can be released. Such a releasing operation is referred to as vacuum breakdown. Alternatively, the suction device 51 may be made open to the air to release the holding of the medicine package 2.

The carriage 50 of the medication support device 200 according to the examples is further provided with a suction-device driver that is an example of the drive motor 63. The CPU according to the above examples controls the conveyor 90, the drive motor 63, and the negative-pressure generator 45 in conjunction with each other. By so doing, the picking-out operation and the placing operation are performed as described above.

The carriage 50 is provided with a recognition unit including the QR code reader. Such a recognition unit scans and reads, for example, a QR CODE related to patients who take medicines or times of medication, and such a QR CODE is displayed on the cartridges 10, the rooms 33 of the medicine dispensing tray 30, or sorting boxes. The CPU performs control to achieve an appropriate medicine dispensing operation while making a comparison between the data read by the recognition unit including the QR code reader and the data of the names of patients who take medicines and the times of medication, which is input and registered in advance.

In the medication support device 200 according to the examples, the signals from a door opening and closing switch, a tray setting switch, or a carriage HP sensor, which are similar to the medicine dispensing tray sensor 156, the container sensor 157, the pair of container gate opening and closing sensor 159a and 159b, and the pair of medicine dispensing tray gate opening and closing sensors 160a and 160b as described above with reference to FIG. 17, are input to the CPU.

### First Example

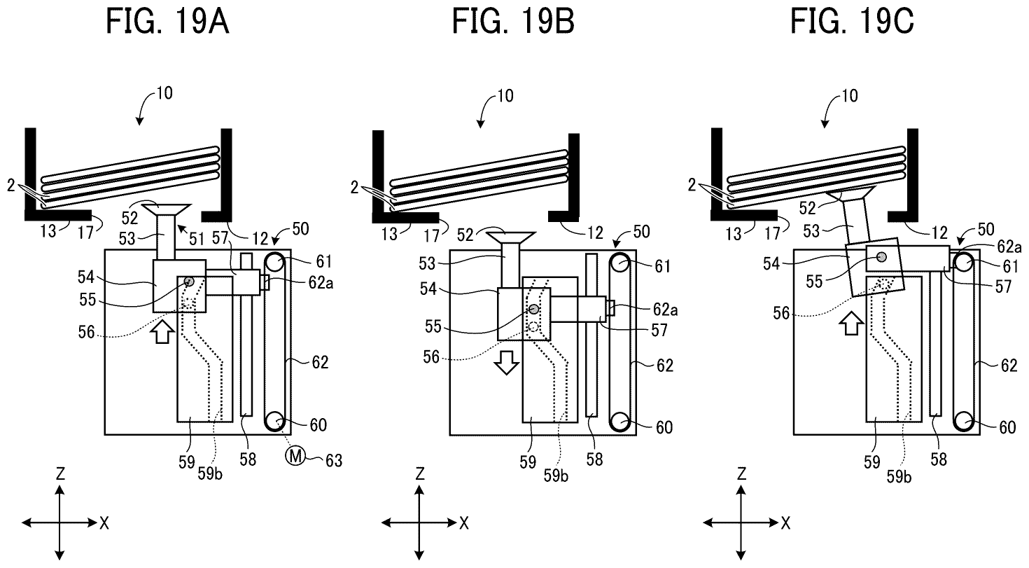

The first example of the embodiments described above with reference to FIG. 1A to FIG. 15B is described below with reference to FIG. 19A to FIG. 21.

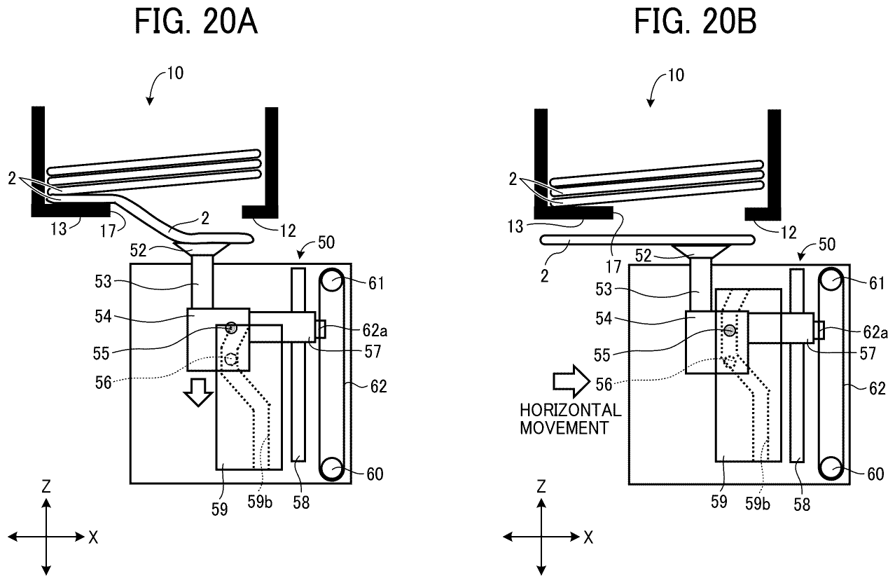

FIG. 19A to FIG. 20B are front views of the carriage 50 according to the first example, illustrating the progression of the picking-out operation of the carriage 50.

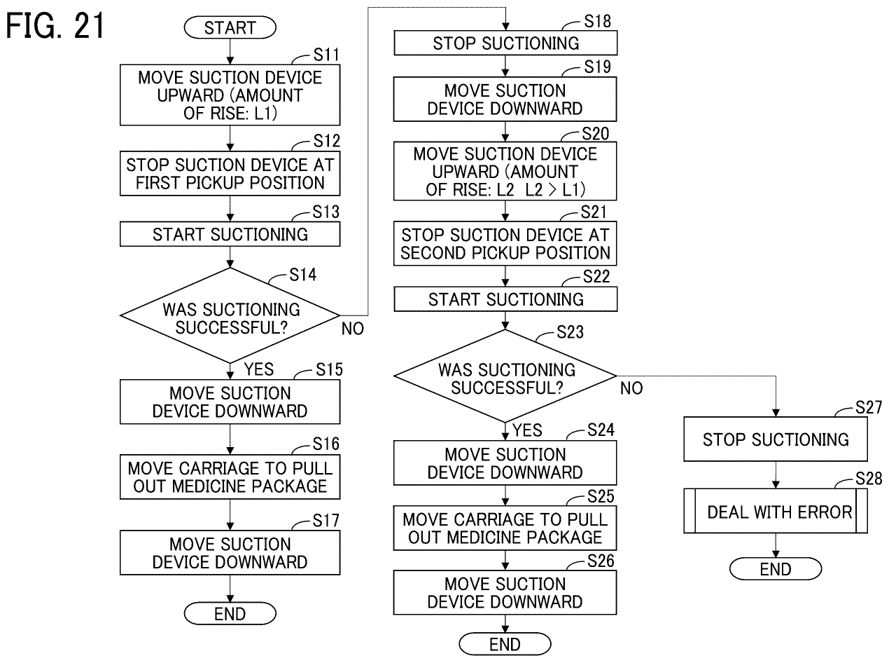

FIG. 21 is a flowchart of the picking-out operation of the carriage 50 according to the first example.

The basic configuration of the cartridge 10 according to the first example to the fourth example as will be described later in detail is equivalent to the configuration illustrated in FIG. 5A and FIG. 5B. The basic configuration of the carriage 50 is equivalent to the configuration illustrated in FIG. 8A and FIG. 8B.

As illustrated in FIG. 21, step S11 to step S17 indicate the progression of the operation when the picking-out operation is successfully performed from the start to the end. These steps are equivalent to step S1 to step S7 depicted in FIG. 13, and indicate the progression of the operation when the picking-out operation is successfully performed. In the control operation as depicted in steps S4, S8, and S9 of FIG. 13, when the suctioning and picking-up operation of the medicine package 2 from the cartridge 10 by the pair of suction pads 52 fails even once, suctioning is immediately terminated, and an error is dealt with. In such a configuration, the order in which the medicine packages 2 stacked on top of each other inside the carriage 50 are to be dispensed may be lost, and the medicine packages 2 cannot orderly and stably be sucked up and taken out. Such a problem is to be handled in the first example.

As illustrated in FIG. 19B, as the drive motor 63 is driven to rotate, in step S11, the suction device 51 moves upward, and enters the cartridge 10. Then, in step S12, the suction device 51 stops at the first pickup position. Note also that L1 indicates the amount of rise of the suction device 51 in those steps. Then, in step S13, suctioning is started. When the suctioning of the lowermost one of the medicine packages 2 in the cartridge 10 by the pair of suction pads 52 of the suction device 51 is not successful (NO in step S14), in step S18, suctioning is stopped, and as illustrated in FIG. 19B, in step S19 of FIG. 21, the pair of suction pads 52 of the suction device 51 are once retracted outside the cartridge 10 and moved downward. Then, as illustrated in FIG. 19C, in step S20, the pair of suction pads 52 of the suction device 51 move upward again, and in step S21, the suction device 51 stops at the second pickup position. Note also that L2 indicates the amount of rise of the pair of suction pads 52 in this step and is greater than L1. The amount of movement of the pair of suction pads 52 in this step may be expressed as the amount of pushing force of the pair of suction pads 52 against the medicine package 2 at the bottom of the cartridge 10.

When the pair of suction pads 52 of the suction device 51 fail to suck up the medicine package 2 at a position around the first pickup position illustrated in FIG. 19A indicating a certain amount of rise of the pair of suction pads 52 of the suction device 51 relative to the medicine package 2 at the bottom of the cartridge 10, an attempt to pick up the medicine package 2 at the bottom of the cartridge 10 is made again at the second pickup position as illustrated in FIG. 19C indicating another amount of rise of the pair of suction pads 52 greater than the certain amount of rise at the first pickup position. By so doing, the probability of success significantly increases after suctioning has failed. In step S22, the pair of suction pads 52 of the suction device 51 start suctioning again. When it is determined that the suctioning is successful (YES in step S23), in step S24, the suction device 51 is moved downward as the drive motor 63 is driven to rotate in the reverse direction while sucking and holding the medicine package 2 at the bottom of the cartridge 10, and one end of the medicine package 2 (on the right side illustrated in FIG. 20A) is pulled out from the cartridge 10. Such a position of the pack in this step may be referred to as a pack pulling-out position in the following description. Then, in step S25, the carriage 50 moves horizontally by the conveying operation of the conveyor 90, and the entirety of the medicine package 2 is pulled out from the cartridge 10. In step S26, the pair of suction pads 52 of the suction device 51 move downward, and rotate and change their posture or attitude by 90 degrees to get prepared for the next placing operation.

On the other hand, when it is determined that the suctioning is not successful (NO in step S23), suctioning is terminated, and an error is dealt with.

According to the first example as described above, the amount of movement of the suction device 51 is increased when the suctioning by the suction device 51 is not successful, and the picking-up operation is performed again. By so doing, errors in picking up the pack due to the failure in sucking up the pack can be reduced.

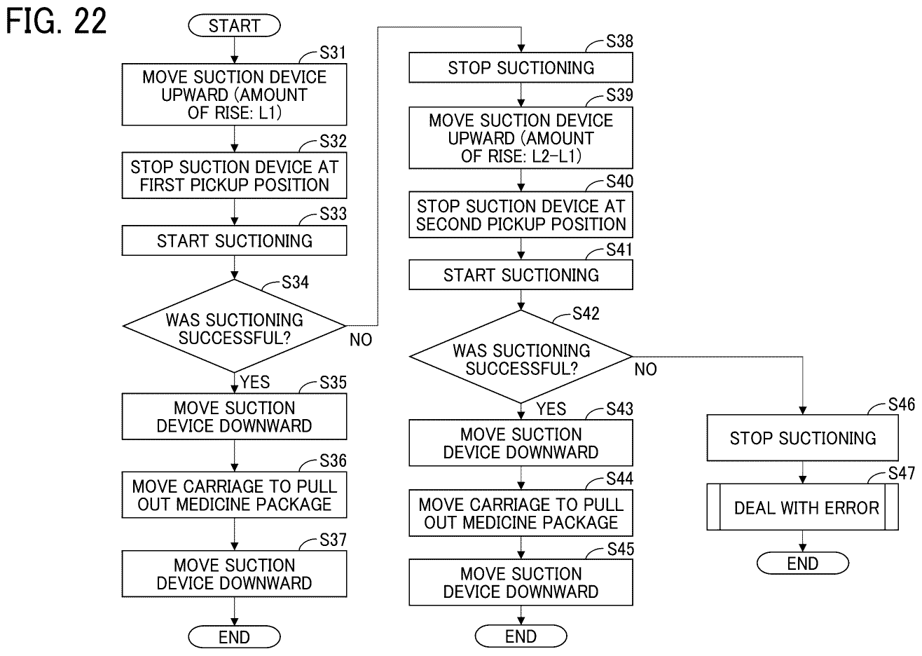

As a modification of the first example, the operations in the flowchart of FIG. 22 may be adopted. Compared with the first example where suctioning is stopped and then the pair of suction pads 52 of the suction device 51 move downward as illustrated in FIG. 19B (see step S19 of FIG. 21), in a modification of the first example, such downward movement is not performed, and the suction device 51 may immediately be moved upward to the second pickup position to perform an attempt to suck up the medicine package 2 again. While the amount of rise of the suction device 51 in step S20 according to the first example is expressed as “L2>L1,” the amount of rise of the suction device 51 in step S39 according to the present modification of the first example is expressed as “L2−L1.”

With the configuration according to the first example and its modification, a suctioning operation has started before the suction device 51 stops at the first pickup position or the second pickup position. Due to such a configuration, the suction device can suck up a pack when it gets close to the pack. However, when a little clearance is left between the medicine package 2 and the pair of suction pads 52 and leakage occurs or when the surfaces of the pair of suction pads are made of soft material, the posture or attitude of the medicine packs get significantly worse after the suctioning operation, or the medicine-dispensing operation to the subdivision boxes may be affected. In order to avoid such a situation, it is desired that suctioning be started after the suction device 51 stops at the first pickup position or the second pickup position.

### Second Example

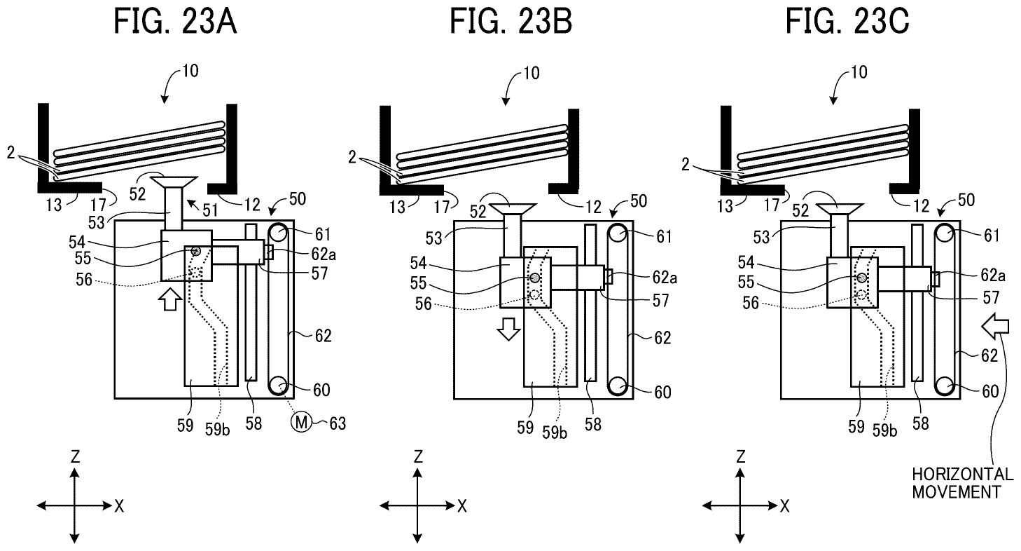

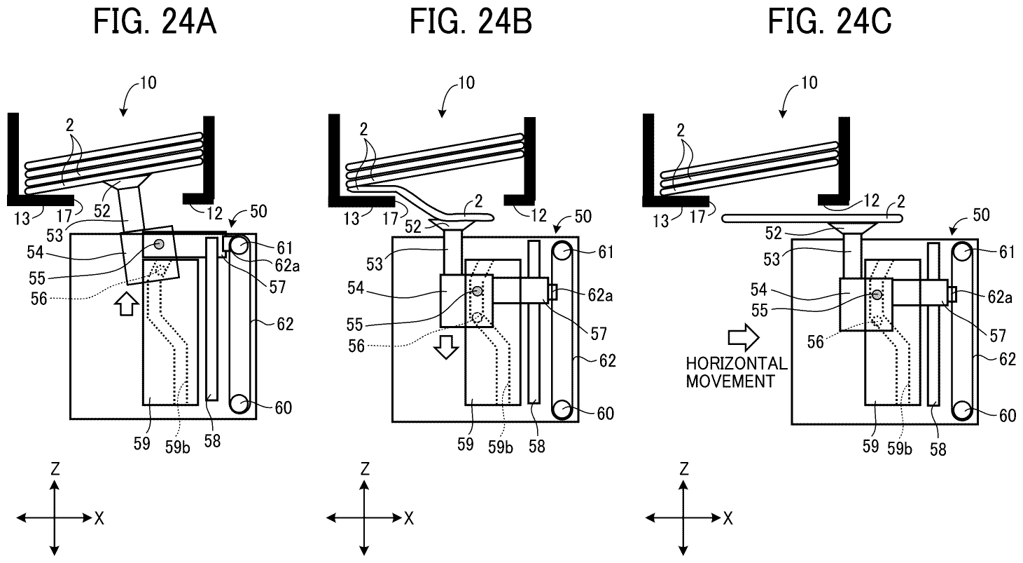

FIG. 23A to FIG. 24C are front views of the carriage 50 according to the second example, illustrating the progression of the picking-out operation of the carriage 50.

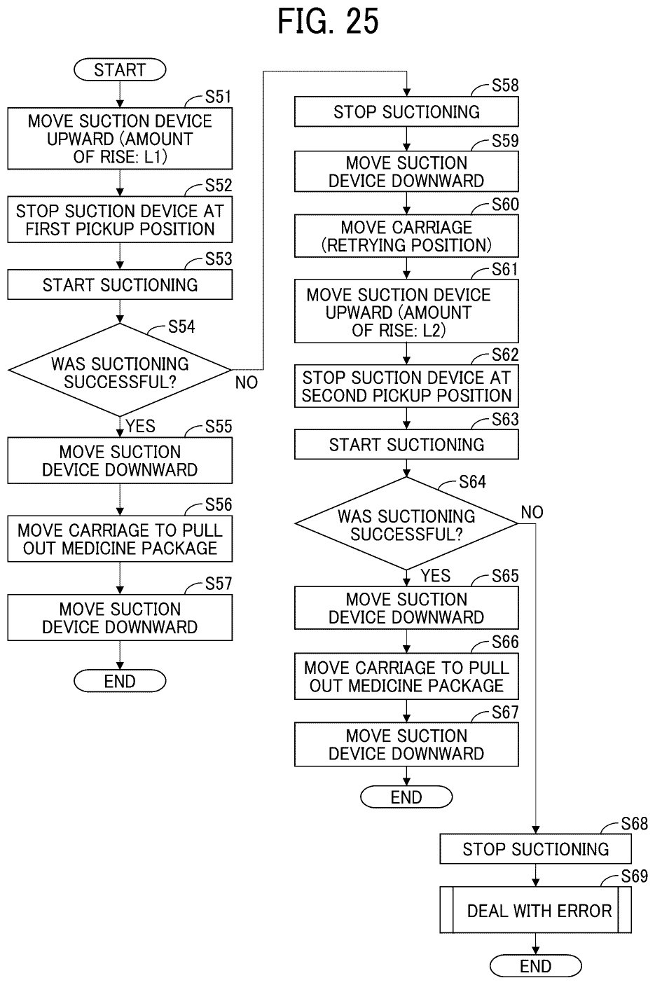

FIG. 25 is a flowchart of the picking-out operation of the carriage 50 according to the second example.

As illustrated in FIG. 23A, as the drive motor 63 is driven to rotate, in step S51, the suction device 51 moves upward, and enters the cartridge 10. Then, in step S52, the suction device 51 stops at the first pickup position. Note also that L1 indicates the amount of rise of the suction device 51 in those steps. Subsequently, in step S52, suctioning is started. When the suctioning of the lowermost one of the medicine packages 2 in the cartridge 10 by the pair of suction pads 52 of the suction device 51 is not successful (NO in step S54), in step S58, suctioning is stopped. Then, as illustrated in FIG. 23B, in step S59 of FIG. 25, the pair of suction pads 52 of the suction device 51 are once retracted outside the cartridge 10 and moved downward.

Then, as illustrated in FIG. 23C, the conveyor 90 changes the position of the carriage 50 in the horizontal direction relative to the cartridge 10 to the central side of the cartridge 10 where the angle of inclination and the height of the medicine package 2 stored in the cartridge 10 are relatively small. In step S60 of FIG. 25, the operation to change the position of the carriage 50 in the horizontal direction relative to the cartridge 10 to the central side of the cartridge 10 is referred to as “move carriage (retrying position).”

Then, as illustrated in FIG. 24A, in step S61, the pair of suction pads 52 of the suction device 51 move upward again, and in step S62, stop at the second pickup position. Note also that L2 indicates the amount of rise of the pair of suction pads 52 in this step. Then, in step S63, suctioning is started again such that, as illustrated in FIG. 24B, the pair of suction pads 52 pull out one end of the medicine package 2 from the cartridge 10 while sucking and holding the medicine package 2 at the bottom of the cartridge 10. Such a position of the pack in this step may be referred to as a pack pulling-out position in the following description.

Then, as illustrated in FIG. 24C, the entirety of the medicine package 2, which is taken out as the carriage 50 is moved by the conveyor 90 in the horizontal direction, is pulled out from the cartridge 10.

On the other hand, when it is determined that the suctioning is not successful (NO in step S64), basically, the series of subsequent operations are equivalent to the series of operations according to the first example described above with reference to FIG. 21 or FIG. 22.

It is desired that the range of the amount of movement of the carriage 50 in the second example be approximately 2 mm with reference to the first pickup position by the suction device 51 for the first time. The retrying position in step S60 of FIG. 25 indicates the amount of movement when the conveyor 90 changes the position of the carriage 50 in the horizontal direction relative to the cartridge 10 to the central side of the cartridge 10.

In the flowchart of FIG. 25, when the carriage 50 has performed the retrying operation to occupy the retrying position in step S60 and suctioning has failed, the processes end with error (see step S63, step S68, and step S69). However, no limitation is indicated thereby, and control may be performed to perform the above retrying operation several times.

According to the second example as described above, the carriage moves to the central side of the medicine package stored in the cartridge, where the angle of inclination and the height of the medicine package 2 stored in the cartridge 10 are relatively small. Due to such a configuration, the suction device can get close to the pack inclined inside the cartridge, and the medicine packs can be sucked up and taken out by the suction device.

### Third Example

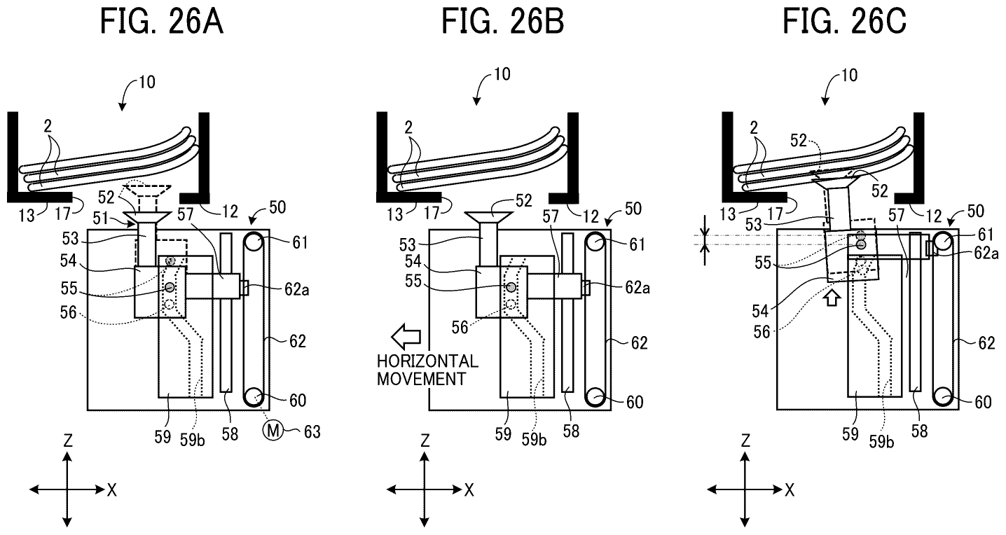

FIG. 26A, FIG. 26B, and FIG. 26C are front views of the carriage 50, illustrating the progression of a retrying operation to be performed after suctioning has failed, which is a part of the picking-out operation of the carriage 50 according to the third example.

In FIG. 26A, FIG. 26B, and FIG. 26C, the operations to pull out the medicine package 2 after suctioning are successful in the retrying operation are described as above.

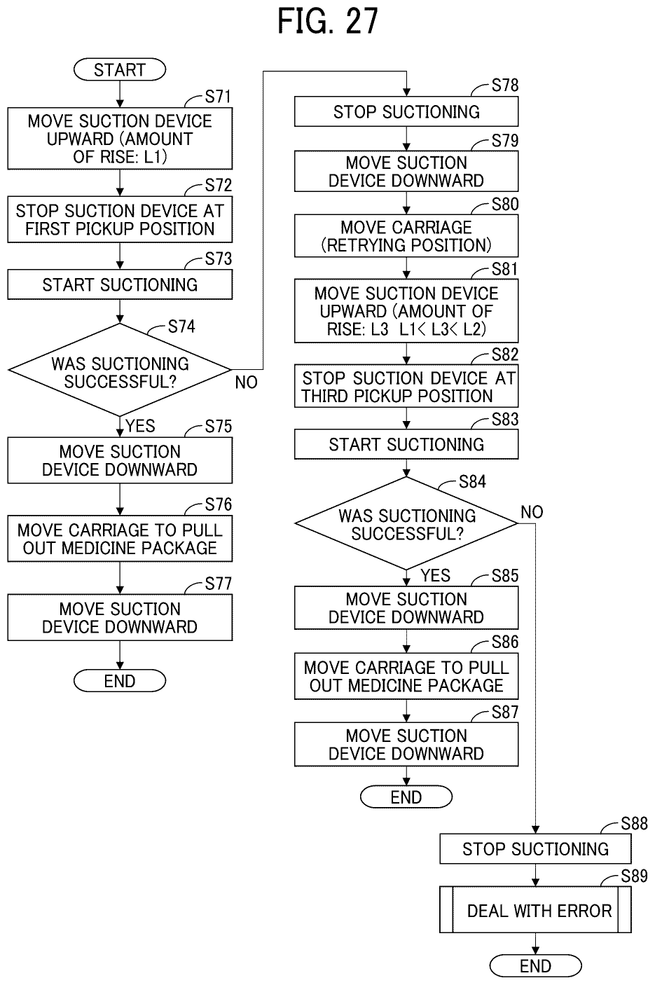

FIG. 27 is a flowchart of the picking-out operation of the carriage 50 according to the third example.

As illustrated in FIG. 26A, as the drive motor 63 is driven to rotate, in step S71, the suction device 51 moves upward and enters the cartridge 10. Then, in step S72, the suction device 51 stops at the first pickup position, where the amount of rise of the suction device 51 is L1. Subsequently, in step S73, suctioning is started. When it is determined that the suctioning is not successful (NO in step S74), in step S78, suctioning is stopped. Then, as illustrated in FIG. 26B, in step S79 of FIG. 27, the pair of suction pads 52 of the suction device 51 are once retracted outside the cartridge 10 and moved downward.

Then, as illustrated in FIG. 23B, the position of the carriage 50 in the horizontal direction relative to the cartridge 10 is changed to the central side of the cartridge 10 by the conveyor 90. In a similar manner to the second example, in step S80 of FIG. 27, the operation to change the position of the carriage 50 in the horizontal direction relative to the cartridge 10 to the central side of the cartridge 10 is referred to as “move carriage (retrying position).”

Then, as illustrated in FIG. 26C, in step S81, the suction device 51 moves upward again. Then, in step S82, the suction device 51 stops at the third pickup position that is higher than the first pickup position and is lower than the second pickup position according to the second example. Then, in step S83, suctioning is started. As described above, in the third example, the picking-up operation is performed at the third pickup position where the amount of rise of the suction device 51 is reduced to an amount smaller than that of the second pickup position.

According to the third example as described above, the carriage moves to the central side of the pack inside the cartridge, and thus the suction device can suck up the pack with a small amount of rise. Accordingly, the edges of the packs can be prevented from being lifted to an excessive degree due to the pushing force when the pack is sucked up by the suction device, and the posture or attitude of the next and following packs to be picked up can be prevented from getting worse.

### Fourth Example

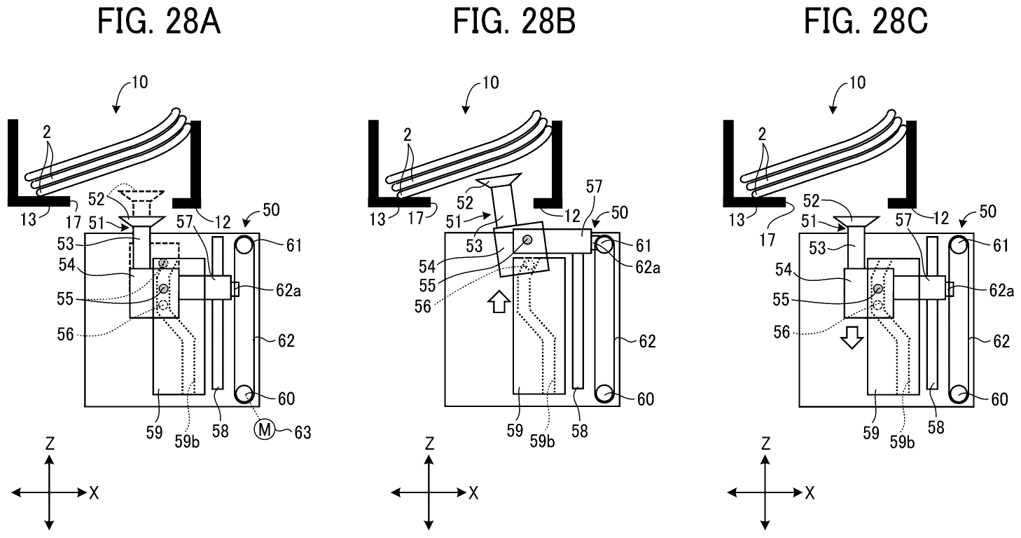

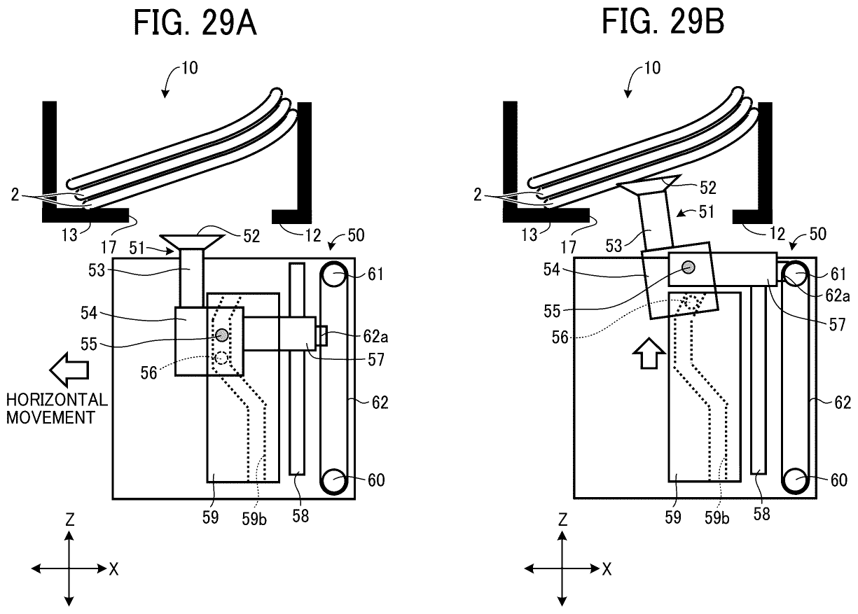

FIG. 28A, FIG. 28B, FIG. 28C, FIG. 29A, and FIG. 29B are front views of the carriage 50, illustrating the progression of a retrying operation to be performed after suctioning has failed, which is a part of the picking-out operation of the carriage 50 according to the fourth example.

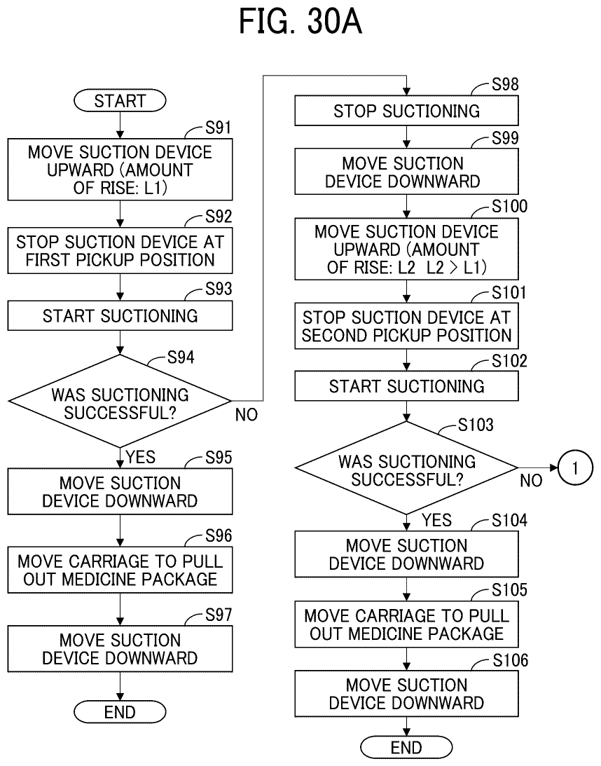

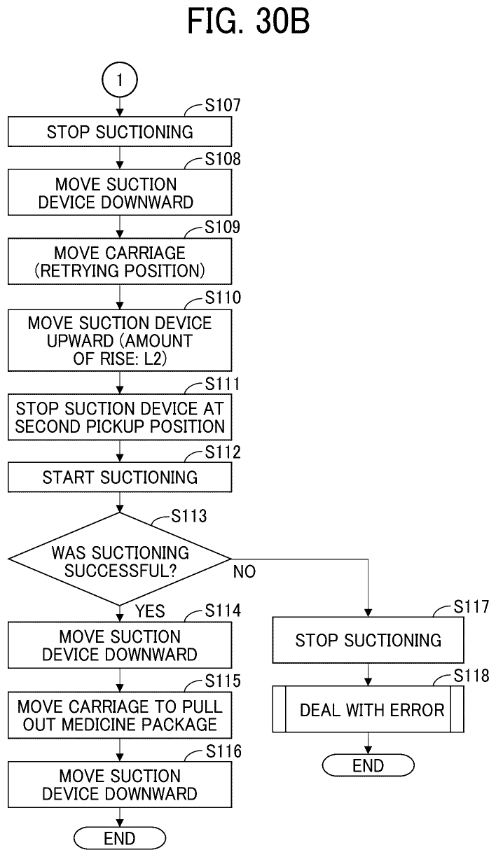

In FIG. 30A and FIG. 30B, the operations to pull out the medicine package 2 after suctioning are successful in the retrying operation are described as above.

FIG. 30A and FIG. 30B are a flowchart of the picking-out operation of the carriage 50 according to the fourth example.

As illustrated in FIG. 28A, in step S91 to step S94 of FIG. 30A, the suction device 51 moves upward where the amount of rise of the suction device 51 is L1, the suction device 51 stops at the first pickup position, suctioning on the medicine package 2 starts, and determination as to whether suctioning is successful is made. The retrying operation after such suctioning of the medicine package 2 as above is not successful is described below. The operations to pull out the medicine package 2 after suctioning are successful in the retrying operation are described as above.

The process shifts to a retrying operation. As illustrated in FIG. 28B, in step S98 to step S102 of FIG. 30A, the suction device 51 moves upward again, stops at the second pickup position, and then starts suctioning.

When suctioning is not successful after suctioning has started in step S103 of FIG. 30A, in step S107, suctioning is stopped. Then, as illustrated in FIG. 28C, in step S108 of FIG. 30B, the suction device 51 moves downward and is once retracted outside the cartridge 10. Subsequently, the carriage 50 occupies the position as illustrated in FIG. 29A as the carriage 50 is horizontally moved by the conveyor 90. When the carriage 50 occupies the retrying position as illustrated in FIG. 29A,

As illustrated in FIG. 29B, in step S110 of FIG. 30B, the suction device 51 moves upward again, and in step S111, stops at the second pickup position. Then, in step S112, suctioning is started.

When suctioning operation is successful in the above retrying operation (YES in step S113 of FIG. 30B), in step S114 to step S116, the operation to pull out the medicine package 2 is performed in a similar manner to step S104 to step S106 of FIG. 30A.

### Fifth Example

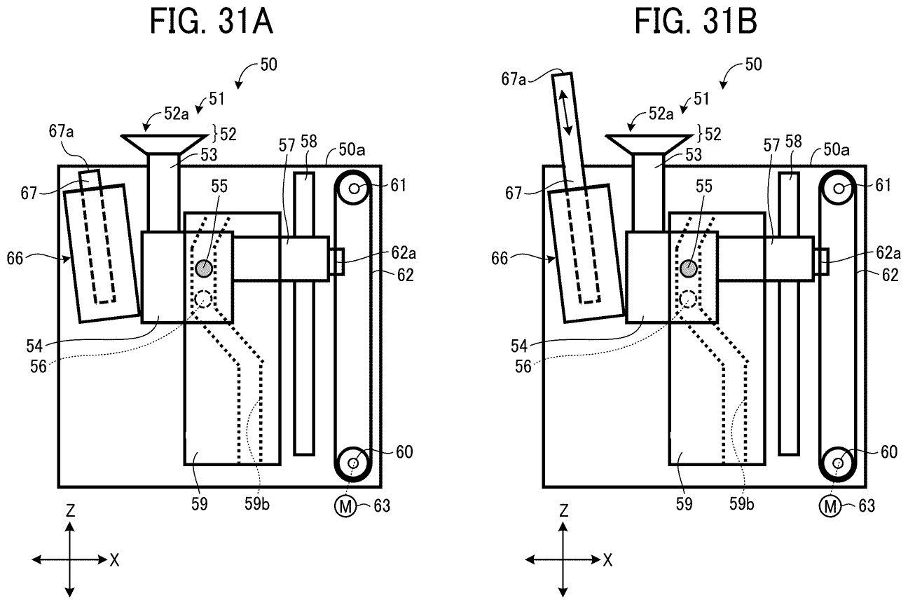

FIG. 31A and FIG. 31B are front views of the carriage 50 according to the fifth example, illustrating the operation and structure of the carriage 50.

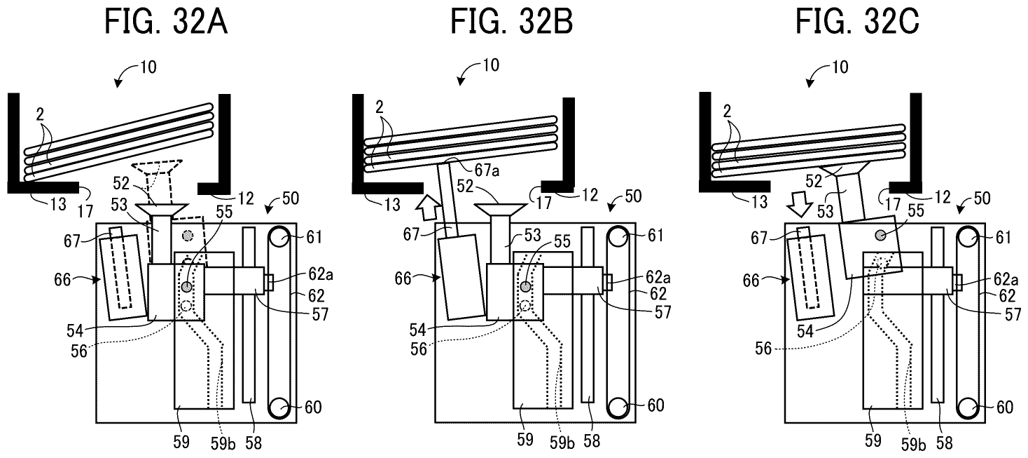

FIG. 32A, FIG. 32B, and FIG. 32C are front views of the carriage 50, illustrating the progression of a retrying operation to be performed after suctioning has failed, which is a part of the picking-out operation of the carriage 50 according to the fifth example.

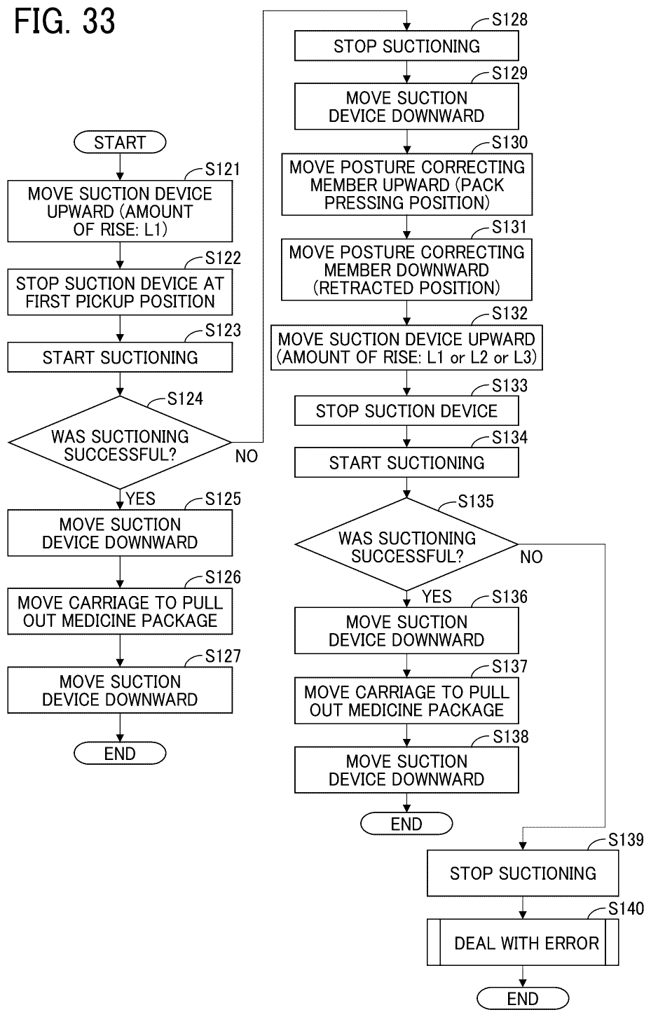

FIG. 33 is a flowchart of the picking-out operation of the carriage 50 according to the fifth example.

The carriage 50 according to the fifth example as illustrated in FIG. 31 is different from the carriage 50 according to the first example to the fourth example in that the former is provided with a posture correction unit 66 including a posture-correcting member 67 that is an example of a posture correction device and corrects the posture or attitude of the medicine packages 2 inside the cartridge 10. Apart from the above difference in configuration or structure, the carriage 50 according to the fifth example has a configuration or structure similar to that of the carriage 50 according to the first example to the fourth example.

The posture correction unit 66 includes a posture-correcting member 67 that linearly reciprocates, a solenoid 68 including, for example, a pushing driver that linearly moves a front end 67a of the posture-correcting member 67 in a projecting direction, and a biasing member such as a tension spring that biases the posture-correcting member 67 in a pulling direction so as to restore it to the original position. The solenoid 68 and the biasing member linearly reciprocate the posture-correcting member 67. By so doing, the front end 67a of the posture-correcting member 67 contacts and pushes the medicine packages 2 inside the cartridge 10. This enables automatic switching between a retracted position where the front end 67a of the posture-correcting member 67 is separated from the medicine packages 2 inside the cartridge 10 and retracts into the carriage 50 (see FIG. 31A) and a pack-pushing position to correct the posture or attitude of the medicine packages 2 inside the cartridge 10 (such as the medicine packages 2 inside the cartridge 10 that are inclined toward the left and their right portions are raised up as described above in the first example with reference to, for example, FIG. 20A and FIG. 20B) (see FIG. 31B).

Typically, the posture-correcting member 67 has a stick-like shape, rod-like shape, or a plate-like shape. However, no limitation is indicated thereby, and it is desired that the posture-correcting member 67 have a shape pushing up wide portions of the medicine packages 2 inside the cartridge 10 in the horizontal or width direction. The posture correction unit 66 or the solenoid 68 according to the fifth example are surrounded by broken lines in FIG. 17 and FIG. 18.

The posture correction unit 66 is not limited to a combination of the above elements, and may include, for example, a posture-correcting member that rotates in a go and return manner and a motor that rotates this posture-correcting member. This also enables automatic switching between a pack-pushing position to correct the posture or attitude of the medicine packages 2 inside the cartridge 10 and a retracted position where the posture-correcting member is separated from the medicine packages 2 inside the cartridge 10 and retracts into the carriage 50.

The operation according to the fifth example is described below with reference to FIG. 32A, FIG. 32B, and FIG. 32C. The operations performed before the suction device 51 enters the cartridge 10 and the operations to pull out the medicine package 2 after suctioning is successful in the retrying operation are described as above.

As indicated by broken lines in FIG. 32A, when the pair of suction pads 52 move upward where the amount of rise of the pair of suction pads 52 is L1, suctioning of the medicine package 2 inside the cartridge 10 has failed (NO in step S124 of FIG. 33), and the process shifts to a retrying operation. In the above retrying operation, as illustrated in FIG. 32B, in step S128 to step S131 of FIG. 33, the solenoid 68 is turned on and driven, and the front end 67a of the posture-correcting member 67 enters the cartridge 10. As the front end 67a occupies a pack-pushing position to contact and push up the medicine package 2 at the bottom as indicated by a large hollow arrow, the posture or attitude of the medicine packages 2 changes. In the above operation to change the posture or attitude of the medicine package 2, the right edges of the medicine packages 2 that are inclined upward and are caught by the inner wall of the cartridge 10 are released, and the medicine package 2 is pushed up such that the edges of the medicine packages 2 on the bottom left in FIG. 32B are separated from the inner bottom face of the cartridge 10 and contact the side surface of the cartridge 10 on the left in FIG. 32B.

Subsequently, as illustrated in FIG. 32C and depicted in step S131 of FIG. 33, the posture-correcting member 67 moves downward to retract from the cartridge 10 as indicated by a large hollow arrow. Then, as depicted in step S132 of FIG. 33, the pair of suction pads 52 of the suction device 51 move upward again to enter the cartridge 10. Under such conditions, the amount of rise of the pair of suction pads 52 of the suction device 51 may be any one of L1, L2, and L3.

In the fifth example, the front end 67a of the posture-correcting member 67 is located near the suction device 51 on the left side as illustrated in FIG. 32A to FIG. 32C, and is movable between the pack-pushing position and retracted position. Due to such a configuration, in the fifth example, effects similar to the retrying operation according to the second example are achieved. In such effects according to the second example, the carriage moves to the central side of the medicine package stored in the cartridge, where the angle of inclination and the height of the medicine package 2 stored in the cartridge 10 are relatively small.

According to the fifth example as described above, when suctioning has failed, the posture or attitude of the packs inside the cartridge 10 is changed by the posture correction device before the above retrying operation is performed. By so doing, the pack can orderly be taken out from the cartridge 10.

### Sixth Example

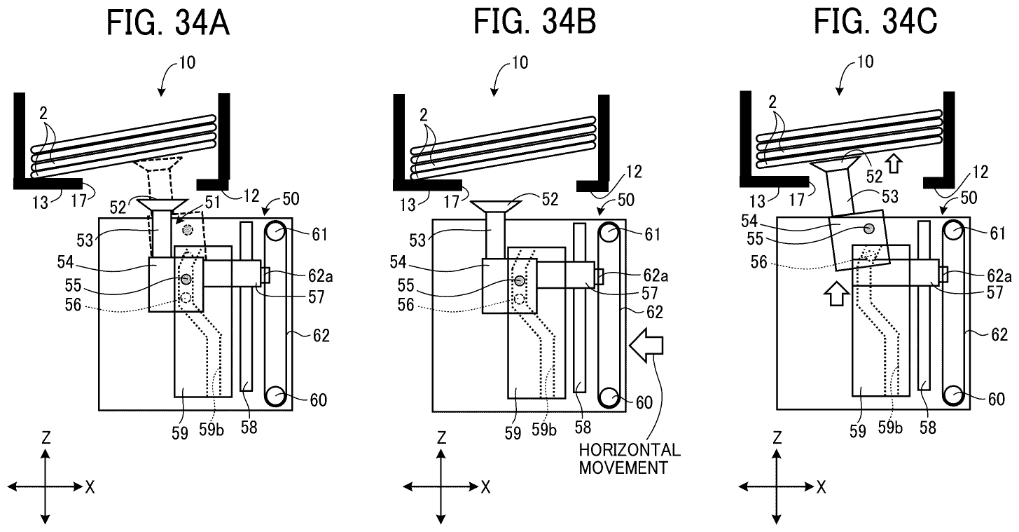

The sixth example is described below with reference to FIG. 34A to FIG. 36B.

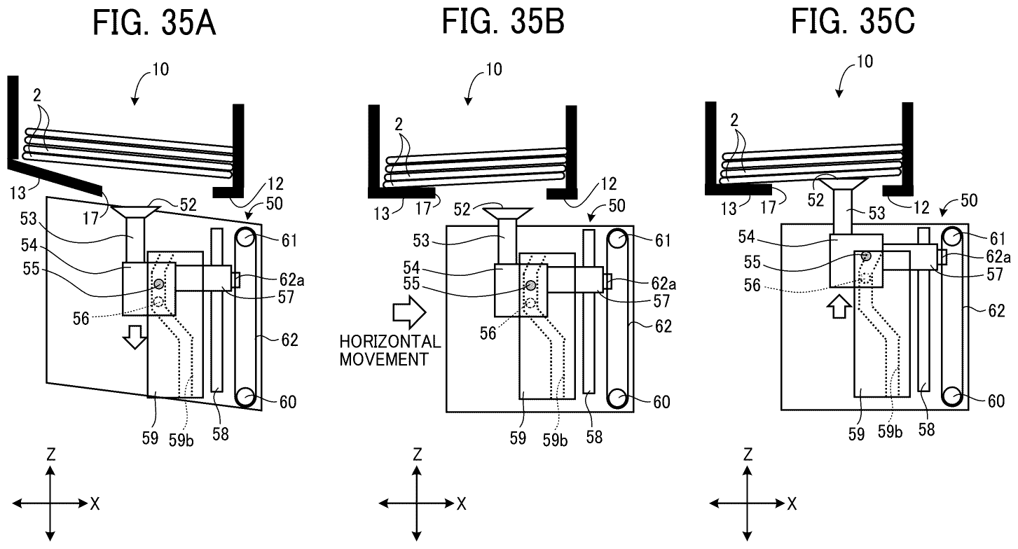

FIG. 34A to FIG. 35C are front views of the carriage 50, illustrating the progression of a retrying operation to be performed after suctioning has failed, which is a part of the picking-out operation of the carriage 50 according to the sixth example.

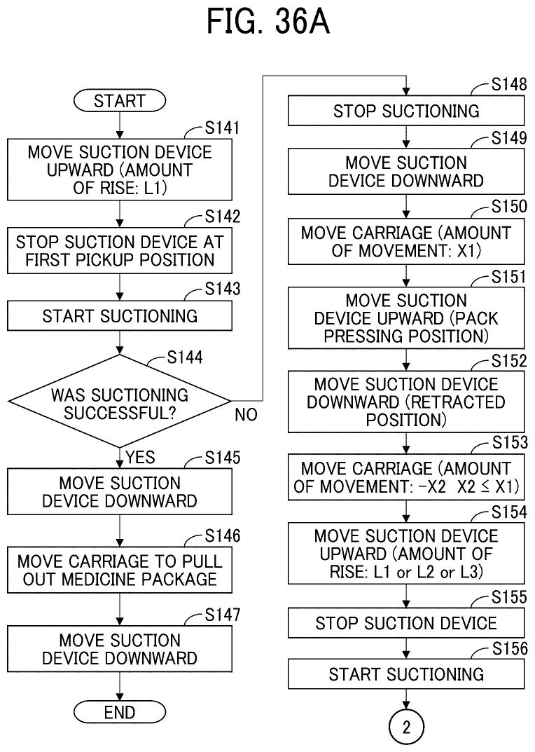

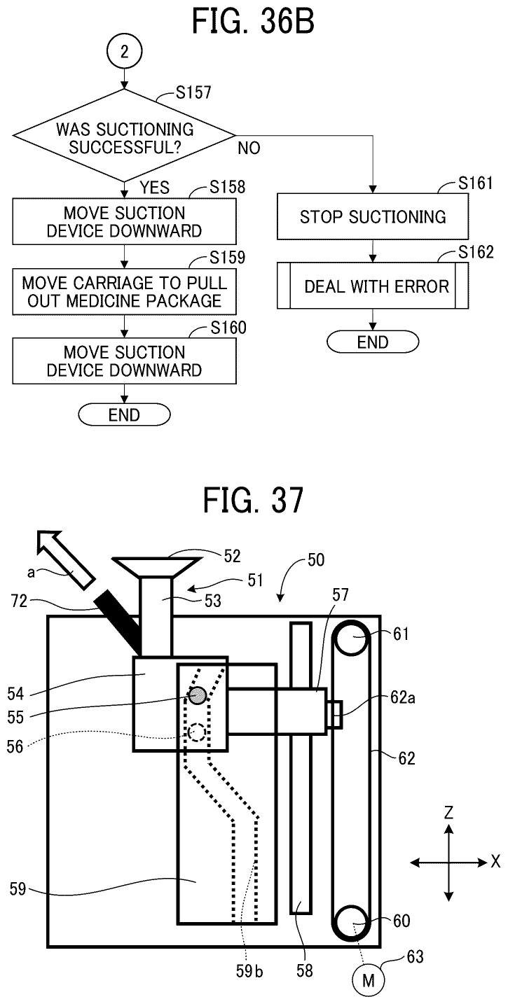

FIG. 36A and FIG. 36B are flowcharts of the picking-out operation of the carriage 50 according to the sixth example.

The carriage 50 according to the sixth example, as will be described below with reference to FIG. 34A to FIG. 35C, has a configuration or structure similar to that of the carriage 50 according to the first example to the fourth example, but perform a specific operation and exerts an effect similar to that of the fifth example as described above.

In FIG. 36A and FIG. 36B, the operations performed before the suction device 51 enters the cartridge 10 and the operations to pull out the medicine package 2 after suctioning is successful in the retrying operation are described as above.

As indicated by broken lines in FIG. 34A, suctioning of the medicine package 2 in the cartridge 10 has failed when the suction device 51 moves upward, and the process shifts to a retrying operation. As illustrated in FIG. 34B, in steps S148 to S150 of FIG. 36A, the suction device 51 is moved downward, and then the carriage 50 is moved by the conveyor 90 in an upstream direction, i.e., to the left in the X-axis direction, where the amount of movement of the carriage 50 is X1. Subsequently, as illustrated in FIG. 34C, in step S151 of FIG. 36A, the pair of suction pads 52 of the suction device 51 are moved upward with no suctioning to push up the medicine packages 2 inside the cartridge 10 and change the posture or attitude of the medicine packages 2 in a similar manner to the operation at the pack-pushing position according to the fifth example.

Subsequently, as illustrated in FIG. 35A, in step S152 of FIG. 36A, the pair of suction pads 52 of the suction device 51 are moved downward with no suctioning in a similar manner to the operation at the retracted position according to the fifth example. After the posture or attitude of the medicine package 2 is corrected, as illustrated in FIG. 35B, in step S153 of FIG. 36A, the carriage 50 is horizontally moved by the conveyor 90 to move the carriage 50 to a position at which a pack is to be picked up, where the amount of movement of the carriage 50 is −X2 and X2≤X1. Subsequently, as illustrated in FIG. 35C, in step S154 of FIG. 36A, the suction device 51 moves upward again, and enters the cartridge 10 to suck up and pick up the medicine packages 2 at the bottom.

In the sixth example, the carriage and the suction device are moved to change their positions as follows. Firstly, suctioning is not successful at the initial sucking position. Secondly, the carriage is moved to a posture correction position to perform posture correction. Then, the carriage is moved to a retrying position to perform a retrying operation. The relative positions of the initial sucking position, the retrying position, and the posture-correcting position in the vertical direction with reference to the upper end of the medicine packages that are inclined obliquely upward to the right inside the cartridge are in the order listed.

According to the sixth example as described above, whereas the initial sucking position is on the top-edge side, the pair of suction pads of the suction device push the bottom edge of a medicine pack that is inclined obliquely downward to the left in the cartridge, with no suctioning. By so doing, the pack can be taken out after its posture or attitude is changed. The posture of a pack can be corrected with no additional component unlike the fifth example.

### Seventh Example

FIG. 37 is a front view of the carriage 50 according to the seventh example, illustrating a schematic configuration or structure of the carriage 50.

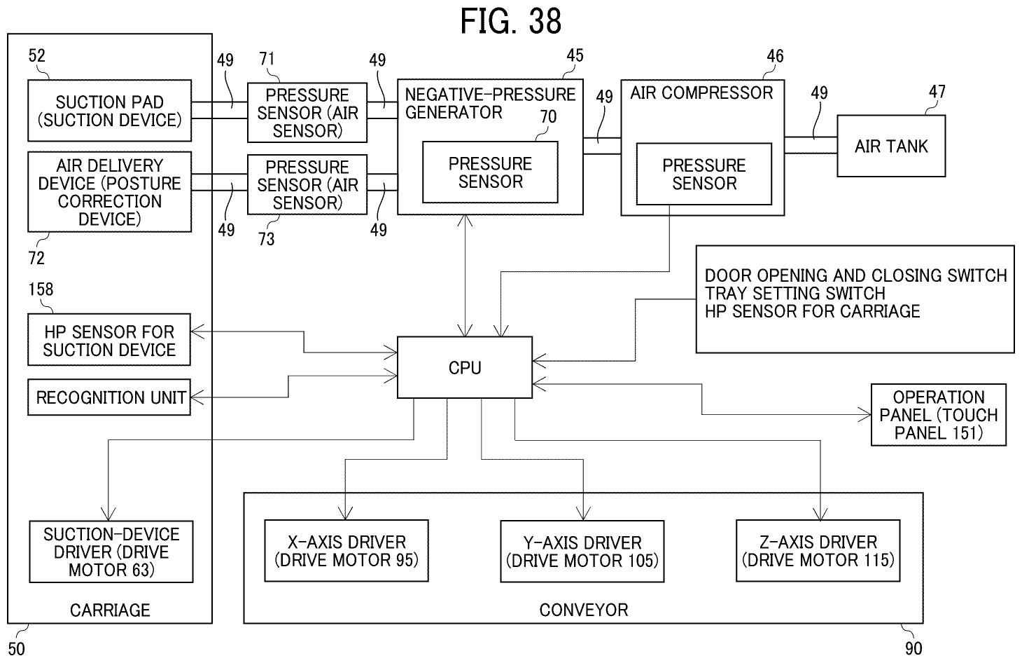

FIG. 38 is diagram illustrating the control blocks of the medication support device 200 according to the seventh example.

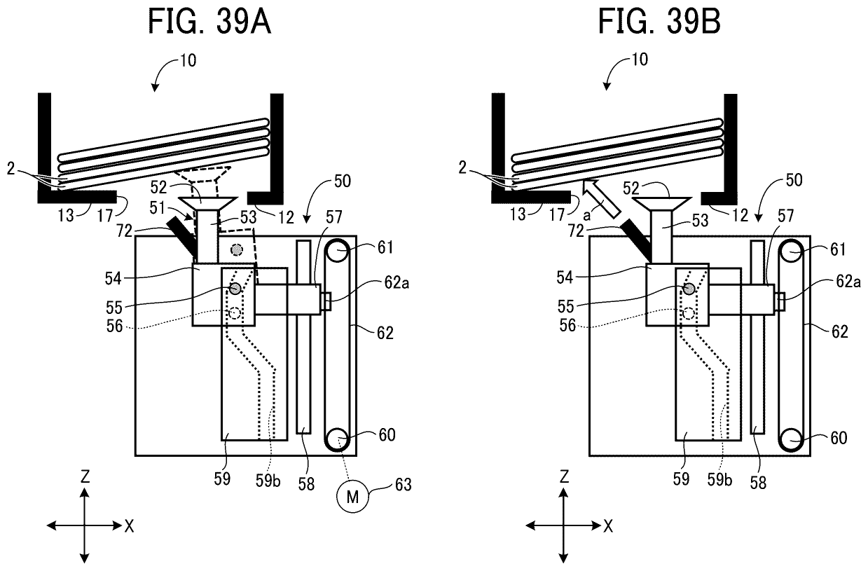

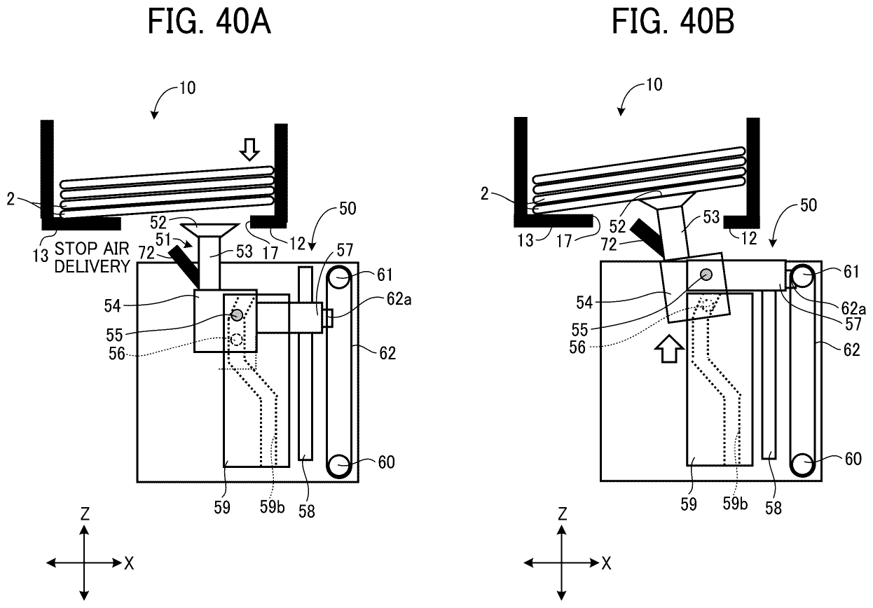

FIG. 39A to FIG. 40B are front views of the carriage 50, illustrating the progression of a retrying operation to be performed after suctioning has failed, which is a part of the picking-out operation of the carriage 50 according to the seventh example.

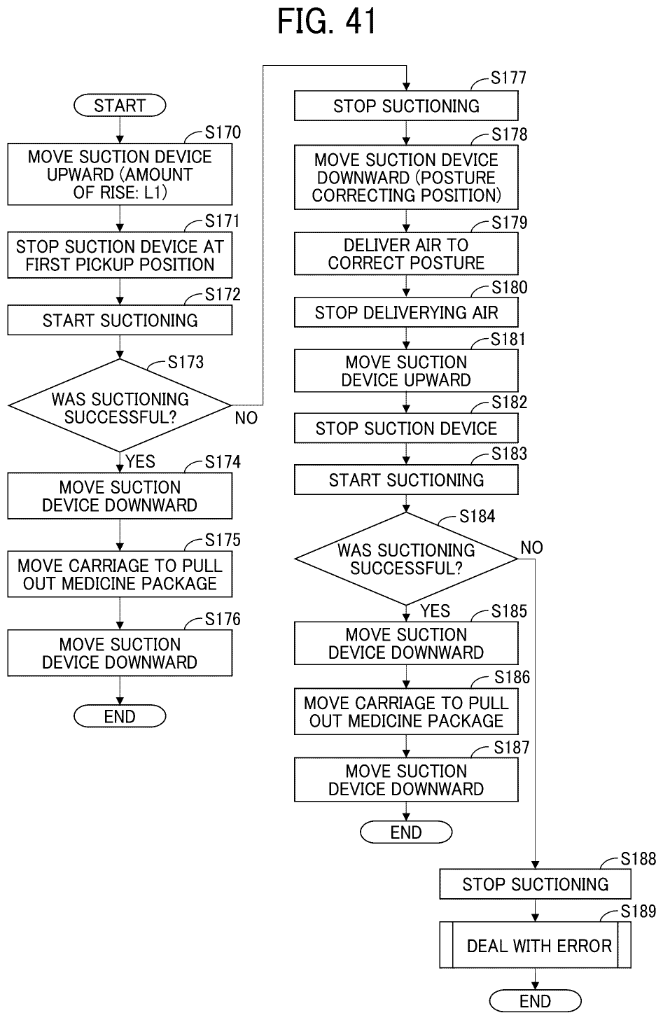

FIG. 41 is a flowchart of the picking-out operation of the carriage 50 according to the seventh example.

As illustrated in FIG. 37, the carriage 50 illustrated in FIG. 8A and FIG. 8B is further provided with an air delivery device 72 that is an example of a posture correction device. It is desired that the air delivery device 72 be arranged near the suction device 51 and movable up and down in a similar manner to the suction device 51. As illustrated in FIG. 38, in the control structure of the medication support device 200 according to the seventh example, the air delivery device 72 is connected to the negative-pressure generator 45 and the air compressor 46 through the air duct 49 that is an air conveyor such as a tube. In addition to the suctioning operation, the negative-pressure generator 45 may use the compressed air to send out compressed air or pressure like when vacuum breakdown is performed as described above.

In the air duct 49 between the negative-pressure generator 45 and the air delivery device 72, a pressure sensor 73 that detects the compressed air or pressure generated by the negative-pressure generator 45 is arranged in addition to the pressure sensor 71 that detects negative pressure under normal operating conditions.

The operation according to the seventh example is described below with reference to FIG. 39A to FIG. 40B. In a similar manner to the examples described above, the operations performed before the suction device 51 enters the cartridge 10 and the operations to pull out the medicine package 2 after suctioning is successful in the retrying operation are performed.

As indicated by broken lines in FIG. 39A, suctioning of the medicine package 2 in the cartridge 10 has failed, and the suction device 51 retracts. However, under such circumstances, it is not necessary for the pair of suction pads 52 to retract from the cartridge 10 completely, and it is satisfactory as long as the pair of suction pads 52 are at the posture correcting position. Then, as illustrated in FIG. 39B, the air a is sent out from the air delivery device 72 toward the medicine package 2 inside the cartridge 10 for prescribed length of time. Then, as illustrated in FIG. 39C, after the air a is sent out for prescribed length of time, the delivery of the air a is stopped. By so doing, the errors as described above with reference to FIG. 15A and FIG. 15B can be corrected. In other words, the medicine packages 2 that are caught by an inner side face of the cartridge and inclined, where their right portions are raised up inside the cartridge 10, spread out.

### Eighth Example

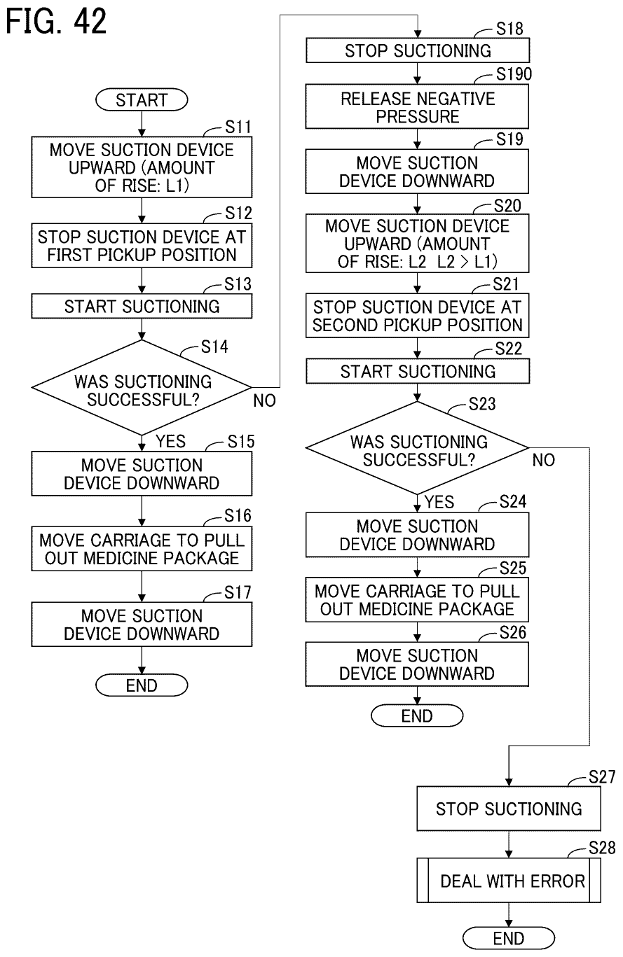

FIG. 42 is a flowchart of the picking-out operation of the carriage 50 according to the eighth example.

In the eighth example, when the suctioning of the lowermost one of the medicine packages 2 in the cartridge 10 by the pair of suction pads 52 of the suction device 51 is not successful in the operation according to the first example and when it is determined that the suctioning is not successful (NO in step S14), in step S18, suctioning is stopped. Then, in step S190, the negative pressure on the pair of suction pads 52 is released before the pair of suction pads 52 of the suction device 51 are moved downward. After the negative pressure on the pair of suction pads 52 is released, the pair of suction pads 52 of the suction device 51 are once retracted outside the cartridge 10 and moved downward.

When the pair of suction pads 52 of the suction device 51 fail to suck up the medicine package 2 appropriately, the suctioning of the medicine package 2 is not successful. If the negative pressure on the pair of suction pads 52 is remaining when the pair of suction pads 52 of the suction device 51 are to be moved downward, there are some cases in which the medicine package 2 is drawn out from the cartridge 10 in an unintentional manner as pulled by the negative pressure on the pair of suction pads 52 that move downward. In such cases, the operation to pick up the medicine pack to be performed again later on may be disturbed, or the medicine package 2 that has been drawn out may fall off. According to the eighth example, the negative pressure on the pair of suction pads 52 is released before the pair of suction pads 52 are moved downward, and the medicine package 2 can be separated from the pair of suction pads 52 in a stable manner before the pair of suction pads 52 move downward.

For example, the negative pressure on the pair of suction pads 52 of the suction device 51 may be released by generating pressure using the negative-pressure generator 45 to send out the air to the pair of suction pads 52 of the suction device 51. By so doing, the air discharges at the suck-and-hold planes 52a of the pair of suction pads 52. For example, the negative pressure on the pair of suction pads 52 of the suction device 51 may be released by letting the pair of suction pads 52 of the suction device 51 open to the atmosphere.

In the above description of the eighth example, the operations in the first example are cited as an example. However, no limitation is indicated thereby, and the releasing of negative pressure in step S190 according to the eighth example is similarly applicable to cases in which the pair of suction pads 52 of the suction device 51 are to be moved downward after the suction device 51 fails to suck up the medicine package 2 at the first pickup position or the second pickup position. For example, step S190 in the eighth example may be performed between step S58 and step S59 in the second example, between step S78 and step S79 in the third example, between step S98 and step S99 and between step S107 and step S108 in the fourth example, between step S128 and step S129 in the fifth example, between step S148 and step S149 in the sixth example, or between step S177 and step S178 in the seventh example.

The above embodiments and examples of the present disclosure described above substantially include, for example, the following aspects.

### First Aspect

A medication support apparatus such as the medication support device 200 includes a container such as the cartridge 10 that stores a plurality of medicine packs such as the medicine packages 2 stacked on top of each other in layers, a pickup device such as the carriage 50 that includes a suction device such as the suction device 51 to pick up specific one of the plurality of medicine packs from the container, and a suction-device guide such as the guide unit 59 that changes a posture of the suction device, a conveyor such as the conveyor 90 that moves the pickup device, and a controller such as the controller to control an operation to pick up the specific one of the plurality of medicine packs by the pickup device. When the suction device fails to pick up the specific one of the plurality of medicine packs at a first pickup position indicating a certain amount of rise of the suction device relative to the plurality of medicine packs in the container, the operation to pick up the specific one of the plurality of medicine packs is performed at a second pickup position indicating another amount of rise of the suction device greater than the certain amount of rise of the suction device at the first pickup position.

According to the first aspect, the medicine packs that are stacked on top of each other inside the container can orderly and stably be sucked up and taken out. In other words, the amount of pushing force against the multiple medicine packs stored in the container when the suction device moves upward is changed, and the operation to pick up the medicine pack is performed again. Due to such a configuration, the medicine packs that are caught and inclined inside the container can be sucked up and taken out.

### Second Aspect

In the medication support apparatus according to the first aspect, when the suction device fails to pick up the specific one of the plurality of medicine packs at the first pickup position, a position of the pickup device relative to the container in a horizontal direction is changed to a central side of the container, and the operation to pick up the specific one of the plurality of medicine packs is performed again at the second pickup position.

According to the second aspect, the pickup device moves to the central side of the medicine pack, which is stored in the container, in the horizontal direction. By so doing, the suction device can get close to the medicine pack, and the medicine packs can be sucked up and taken out by the suction device.

### Third Aspect

In the medication support apparatus according to the second aspect, the operation to pick up the specific one of the plurality of medicine packs is performed at a third pickup position indicating still another amount of rise of the suction device smaller than the another amount of rise at the second pickup position.

According to the third aspect, the pickup device moves to the central side of the medicine pack, which is stored in the container, in the horizontal direction. Accordingly the suction device can suck up the medicine pack with a small amount of rise. Accordingly, the edges of the medicine packs can be prevented from being lifted to an excessive degree due to the pushing force when the medicine pack is sucked up by the suction device, and the posture or attitude of the next and following medicine packs to be picked up can be prevented from getting worse.

### Fourth Aspect

In the medication support apparatus according to any one of the first to third aspects, when the suction device fails to suck up the specific one of the plurality of medicine packs at the second pickup position, the operation to pick up the specific one of the plurality of medicine packs is performed again at the second pickup position or the operation to pick up the specific one of the plurality of medicine packs is performed at a third pickup position indicating still another amount of rise of the suction device smaller than the another amount of rise at the second pickup position.

According to the fourth aspect, the retrying operation according to the first aspect and the retrying operation according to the second aspect or the third aspect may be combined with each other so as to reduce the rate of occurrence of an error in suctioning.

### Fifth Aspect

In the medication support apparatus according to one of the first to fourth aspects, the pickup device includes a posture correction device such as the posture-correcting member 67 to correct a posture of the plurality of medicine packs inside the container, and the posture correction device corrects the posture of the plurality of medicine packs before the operation to pick up the specific one of the plurality of medicine packs is performed again.

According to the fifth aspect, when suctioning by the suction device 51 is not successful, the medicine pack can orderly be taken out from the container by changing the posture or attitude of the medicine packs using the posture correction device before the above retrying operation is performed.

### Sixth Aspect

In the medication support apparatus according to the fifth aspect, the posture correction device is equivalent to the suction device.

According to the sixth aspect, whereas the initial sucking position is on the top-edge side, the suction device pushes the bottom edge of a medicine pack with no suctioning. By so doing, the medicine pack can be taken out after its posture or attitude is changed. In other words, the posture of a medicine pack can be corrected with no additional component.

### Seventh Aspect

In the medication support apparatus according to the fifth aspect, the posture correction device adopts air delivery.

According to the seventh aspect, the posture or attitude of the medicine packs is changed by the air delivery before the operation to pick up the medicine pack is performed again. By so doing, the medicine pack can be taken out easily.

### Eighth Aspect

In the medication support apparatus according to one of the first to seventh aspects, when the suction device fails to suck up the specific one of the plurality of medicine packs at the first pickup position or the second pickup position, the suction device is moved downward after negative pressure on the suction device to be used for a suctioning operation is released, and the operation to pick up the specific one of the plurality of medicine packs is performed again.

When the suction device has failed to suck up the medicine pack at the first pickup position or the second pickup position, the suction device may be moved downward to perform the operation to pick up the medicine pack again. In such cases, if the negative pressure on the suction device remains, the medicine pack may be pulled out by the negative pressure on the suction device when the suction device is moved downward. Accordingly, the repeated operation to pick up the medicine pack may be disturbed, or the medicine package 2 that has been drawn out may fall off.

According to the eighth aspect, when the suction device has failed to suck up the medicine pack at the first pickup position or the second pickup position, the suction device is moved downward after the negative pressure on the suction device to be used for a suctioning operation is released. For this reason, the negative pressure on the suction device is released before the suction device is moved downward. Accordingly, the medicine pack can be separated from the suction device in a stable manner before the suction device is moved downward, and the medicine pack is prevented from being pulled out by mistake when the suction device is moved downward.

### Ninth Aspect

In the medication support apparatus according to the eighth aspect, compressed air is sent to the suction device to release the negative pressure.

According to the ninth aspect, the negative pressure on the suction device can be released with the use of a configuration or structure to send the compressed air.

### Tenth Aspect

In the medication support apparatus according to the eighth aspect, the suction device is made open to air to release the negative pressure.

According to the tenth aspect, the negative pressure on the suction device can be released with the use of a configuration or structure to make the suction device open to the air.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application-specific integrated circuit (ASIC), digital signal processor (DSP), field-programmable gate array (FPGA), and conventional circuit components arranged to perform the recited functions.

What is claimed is:

1. A medication support apparatus comprising:
a container to store a plurality of medicine packs;
a pickup device including a suction device to pick up specific one of the plurality of medicine packs from the container;
a suction-device guide to change a posture of the suction device;
a conveyor to move the pickup device; and
processing circuitry configured to control an operation to pick up the specific one of the plurality of medicine packs by the pickup device,
wherein, when the suction device fails to pick up the specific one of the plurality of medicine packs at a first pickup position indicating a certain amount of rise of the suction device relative to the plurality of medicine packs in the container, the processing circuitry controls the suction device to pick up the specific one of the plurality of medicine packs at a second pickup position indicating another amount of rise of the suction device greater than the certain amount of rise of the suction device at the first pickup position.

2. The medication support apparatus according to claim 1,
wherein, when the suction device fails to pick up the specific one of the plurality of medicine packs at the first pickup position, the processing circuitry controls the conveyor to change a position of the pickup device relative to the container in a horizontal direction to a central side of the container, and the processing circuitry controls the suction device to pick up the specific one of the plurality of medicine packs again at the second pickup position.

3. The medication support apparatus according to claim 2,
wherein the processing circuitry controls the suction device to pick up the specific one of the plurality of medicine packs at a third pickup position indicating still another amount of rise of the suction device smaller than the another amount of rise at the second pickup position.

4. The medication support apparatus according to claim 1,
wherein, when the suction device fails to suck up the specific one of the plurality of medicine packs at the second pickup position, the processing circuitry controls the suction device to pick up the specific one of the plurality of medicine packs again at the second pickup position or pick up the specific one of the plurality of medicine packs at a third pickup position indicating still another amount of rise of the suction device smaller than the another amount of rise at the second pickup position.

5. The medication support apparatus according to claim 1,
wherein the pickup device includes a posture correction device to correct a posture of the plurality of medicine packs inside the container, and
wherein the processing circuitry controls the posture correction device to correct the posture of the plurality of medicine packs before the operation to pick up the specific one of the plurality of medicine packs again.

6. The medication support apparatus according to claim 5,
wherein the posture correction device is the suction device.

7. The medication support apparatus according to claim 5,
wherein the posture correction device adopts air delivery.

8. The medication support apparatus according to claim 1,
wherein, when the suction device fails to suck up the specific one of the plurality of medicine packs at the first pickup position or the second pickup position, the processing circuitry controls the conveyor to move the suction device downward after negative pressure on the suction device to be used for a suctioning operation is released, and the processing circuitry controls the suction device to pick up the specific one of the plurality of medicine packs again.

9. The medication support apparatus according to claim 8,
wherein compressed air is sent to the suction device to release the negative pressure.

10. The medication support apparatus according to claim 8,
wherein the suction device is made open to air to release the negative pressure.
